(19) United States
(12) Patent Application Publication
(10) Pub. No.: US 2014/0340723 A1
(43) Pub. Date: Nov. 20, 2014

(54) VOLUME HOLOGRAM, MANUFACTURING METHOD THEREOF, AND SHIFT METHOD OF WAVELENGTH SPECTRUM OF DIFFRACTED LIGHT

(71) Applicants: Takashi Matsubara, Shizuoka (JP); Akira Shirakura, Tokyo (JP); Yuji Nakagawa, Kanagawa (JP)

(72) Inventors: Takashi Matsubara, Shizuoka (JP); Akira Shirakura, Tokyo (JP); Yuji Nakagawa, Kanagawa (JP)

(73) Assignees: Sony Corporation, Minato-ku, Tokyo (JP); Sony DADC Corporation, Shinagawa-ku, Tokyo (JP)

(21) Appl. No.: 14/117,546

(22) PCT Filed: May 7, 2012
(86) PCT No.: PCT/JP2012/062242

§ 371 Date: Nov. 13, 2013

(30) Foreign Application Priority Data
May 17, 2011 (JP) 2011-110087
Jan. 10, 2012 (JP) 2012-002012

(51) Int. Cl. G03H 1/00; G03H 1/18

(52) U.S. Cl. CPC G03H 1/0011; G03H 1/182; G03H 2001/0027; G03H 2001/185
USPC 359/2

(57) ABSTRACT

A manufacturing method of the volume hologram includes a step of hologram recording for recording information to a hologram recording layer and a pressing step of the hologram recording layer for pressing at least a portion of the hologram recording layer recorded with the information. In the step of pressing the hologram recording layer, the hologram recording layer recorded with information may change.

### TECHNICAL FIELD

The present disclosure relates to a volume hologram, a manufacturing method thereof, and a shift method of wavelength spectrum of diffracted light. More particularly, the present disclosure relates to a volume hologram, a manufacturing method thereof, and a shift method of wavelength spectrum of diffracted light having a region where a wavelength spectrum of a diffracted light is different.

### BACKGROUND ART

A hologram capable of displaying three-dimensional image is used by a credit card, an identification card, and the like to determine its genuineness. Among holograms, in recent years, a volume hologram is often used. The volume hologram records an interference pattern as a difference of refractive indexes in a recording layer. This is because, in the manufacturing process of the volume hologram, highly sophisticated technique is required to make a recording image, and it is difficult to obtain a recording material.

For example, the volume hologram can be manufactured (mass produced) by bringing a hologram recording material into close contact with or in proximity to a master plate recorded with a hologram (which may be hereinafter referred to as original master plate) and emitting laser light onto the original master plate and the hologram recording material. The method for reproducing the hologram recorded in the master plate with the laser light and copying the hologram to the hologram recording material which has been brought into close contact with or in proximity to the master plate is called a contact copy.

According to the method of the contact copy, it is not totally impossible to illegally copy the by bringing an unexposed hologram recording material into proximity to the genuinely manufactured volume hologram and emitting laser light of a wavelength close to the recording wavelength. Therefore, the genuinely manufactured volume hologram is desired to have the function of copy protection.

A method for giving the function of copy protection to the volume hologram is suggested, for example, in Patent Document 1 shown below. Patent Document 1 suggests attaching a partially patterned optical functional film at a side closer to an observer with respect to a hologram recording layer.

### CITATION LIST

### Patent Document

Patent Document 1: JP 2010-217864 A

### SUMMARY OF THE INVENTION

### Problems to be Solved by the Invention

It is desired to improve the function of copy protection of the volume hologram.

### Solutions to Problems

In a preferred embodiment of a volume hologram, the volume hologram includes one or more regions in which wavelength spectrums of diffracted lights are different.

A preferred embodiment of a volume hologram, the thickness in the region in which the wavelength spectrum of diffracted light is different and the thickness in the remaining region are different.

In another preferred embodiment of a volume hologram, a volume hologram includes a hologram recording layer including one or more regions formed with change.

The region formed with the change is obtained by pressing at least a portion of the hologram recording layer recorded with the information.

A preferred embodiment of a manufacturing method of a volume hologram includes a step of hologram recording for recording information in a hologram recording layer and a pressing step of the hologram recording layer for pressing at least a portion of the hologram recording layer in which the information is recorded.

The pressing step of the hologram recording layer involves change in the hologram recording layer recorded with the information.

In a preferred embodiment of a shift method of a wavelength spectrum of a diffracted light, the wavelength spectrum of the diffracted light is partially changed by partially pressing a photosensitive material.

In the present technique, at least a portion of the hologram recording layer recorded with the hologram is pressed, and this makes change in the hologram recording layer recorded with the information. For example, the pressed portion is cured with the change by curing the hologram recording layer while pressing at least a portion of the hologram recording layer. Alternatively, the not-pressed portion is cured with the change by curing the hologram recording layer while pressing at least a portion of the hologram recording layer.

This change includes change of reduction of the degree of clearness of the interference pattern recorded in a target of copy (copied item) when contact copy is performed, change of a refractive index in a thickness direction, change of an interference pattern, change of a thickness, or change of the wavelength spectrum of the diffracted light when white light is emitted from a predetermined angle. For example, when this change is the change of reduction of the degree of clearness of the interference pattern recorded to the target of copy when contact copy is performed, the degree of clearness of the interference pattern recorded in the copied item is reduced even if a person tries illegal contact copy. Therefore, the function of copy protection of the volume hologram is improved.

For example, in the hologram recording layer, change of the wavelength spectrum of the diffracted light occurs when white light is emitted from a predetermined angle, the wavelength spectrum of the diffracted light from the hologram becomes different between the pressed region and the remaining region. Therefore, when contact copy is performed using laser light having a wavelength close to the recording wavelength, the recorded hologram is not clearly reproduced from the region in which the wavelength spectrum of diffracted light is different, and therefore, in the copied item, recording of the region corresponding to that region is incomplete. More specifically, the function of copy protection of the volume hologram is improved.

In the present technique, after the hologram is recorded to the hologram recording layer, change is generated in at least a portion of the hologram recording layer. Therefore, the region in which the wavelength spectrum of diffracted light is different is formed in the volume hologram, and therefore, it is not necessary to use multiple laser light sources of which recording wavelengths are different.

### Effects of the Invention

According to at least one embodiment, a volume hologram and a manufacturing method thereof having improved function of copy protection against contact copy can be provided.

### BRIEF DESCRIPTION OF DRAWINGS

FIG. 1A is a top view illustrating an example of configuration of a volume hologram according to an embodiment of the present disclosure. FIG. 1B is a schematic view illustrating a portion of A-A cross section of a volume hologram as illustrated in FIG. 1A.

FIG. 2A is a schematic diagram for explaining a measurement method of spectrum characteristics for a recorded photosensitive material. FIG. 2B is a figure illustrating an example of a measurement result of spectrum characteristics.

FIGS. 3A to 3C are schematic diagrams illustrating exposure process for a light-cured photopolymer.

FIG. 4A is a schematic view used to explain contact copy. FIG. 4B is a schematic view used to explain recording of an interference pattern when illegal contact copy is performed using the volume hologram of the present disclosure as a master plate. FIG. 4C is a top view schematically illustrating a reproduced image reproduced from the volume hologram of the present disclosure. FIG. 4D is a top view schematically illustrating a reproduced image reproduced from a recording medium made by illegal contact copy using the volume hologram of the present disclosure as a master plate.

FIGS. 5A to 5D are figures used to explain a hologram recording layer forming step.

FIGS. 6A to 6B are figures used to explain another example of configuration of a hologram recording layer forming step.

FIGS. 7A to 7D are figures used to explain a hologram recording step.

FIG. 8A is a perspective view illustrating an example of configuration of a press die used for a pressing step and an exposure step of a hologram. FIGS. 8B to 8D are figures used to explain the pressing step and the exposure step of a hologram.

FIG. 9A is a figure used to explain the pressing step using a press die in which the ratio of the size of area of a protruding portion is smaller as compared with the size of area of an exposure surface of a hologram recording layer. FIG. 9B is a figure used to explain the pressing step using a press die in which the ratio of the size of area of a protruding portion is larger as compared with the size of area of an exposure surface of a hologram recording layer.

FIG. 10A is a figure illustrating measurement results of spectrum characteristics of sample 1-1 to sample 1-4. FIG. 10B is a figure illustrating points corresponding to peaks diffraction efficiency of sample 1-1 to sample 1-4 which are shown on a chromaticity diagram of Yxy color system defined by CIE.

FIG. 11A is a figure illustrating measurement results of spectrum characteristics of sample 2-1 to sample 2-4. FIG. 11B is a figure illustrating points corresponding to peaks diffraction efficiency of sample 2-1 to sample 2-4 which are shown on a chromaticity diagram of Yxy color system defined by CIE.

FIG. 12A is a top view illustrating a first modification of a volume hologram. FIG. 12B is a top view illustrating a second modification of a volume hologram. FIG. 12C is a top view illustrating a third modification of a volume hologram.

FIG. 13A is a top view illustrating a fourth modification of a volume hologram. FIGS. 13B to 13D are figures used to explain a manufacturing step of a fourth modification of a volume hologram.

### MODE FOR CARRYING OUT THE INVENTION

Hereinafter, an embodiment of a volume hologram, a manufacturing method of the volume hologram and a shift method of wavelength spectrum of diffracted light will be explained. Explanation will be made in the following order.

### <1. Embodiment>

[Overview of embodiment]

[Configuration of volume hologram]

[Copy protection]

[Manufacturing method of the volume hologram]

### <2. Modification>

[First modification of volume hologram]

[Second modification of volume hologram]

[Third modification of volume hologram]

[Fourth modification of volume hologram]

It should be noted that the embodiment explained below is a preferred specific example of the $1 modification of volume hologram. In the explanation below, various kinds of limitations preferred in terms of techniques are given, but unless a description indicating that the present technique is particularly limited, it is to be understood that the example of volume hologram and manufacturing method of the volume hologram and shift method of wavelength spectrum of diffracted light is not limited to the embodiment shown below.

### 1. EMBODIMENT

The volume hologram, the manufacturing method of the volume hologram, and the shift method of wavelength spectrum of diffracted light of the present disclosure is devised as a result of consideration described below.

### Overview of Embodiment

In illegal copying process using contact copy, diffracted light (reproduction light) from a genuinely manufactured volume hologram is used as object light, and the hologram is recorded to a hologram recording material brought into close contact with or in proximity to the genuinely manufactured volume hologram. More specifically, it is necessary to reproduce information recorded in the genuinely manufactured volume hologram, and therefore, laser light of a wavelength close to the recording wavelength of the genuine volume hologram is used in the contact copy.

The volume hologram is characterized in that it can be reproduced by white light. The wavelength of the volume hologram illuminated by white light corresponding to the peak of diffraction efficiency is the same as the recording wavelength used for recording to the volume hologram. For example, when the hologram of the original master plate is recorded to a volume hologram by green laser in which the wavelength is about 532 nm, the wavelength of the volume hologram corresponding to the peak of diffraction efficiency is about 532 nm. Therefore, an image reproduced when an observer observes the volume hologram under white light is perceived as a green color.

In this case, the inventors of the present application has found that illegal contact copy can be effectively prevented by, for example, arranging a region in a portion of the volume hologram, and in this region, the wavelength spectrum of the diffracted light is different from the wavelength spectrum of the diffracted light from the other portion. For example, suppose that, when the volume hologram is illuminated with white light, there are a region in which the recorded hologram is perceived as green color and a region in which the recorded hologram is perceived as red color. For example, when green laser is used in order to illegally copy this volume hologram using contact copy, information in the region in which the hologram is perceived as green color is reproduced, but information in the region in which the hologram is perceived as red color is not reproduced. Therefore, the information in the region in which the hologram is perceived as red color is not recorded to an illegally copied product.

In order to provide a region where the wavelength spectrum of the diffracted light is different, for example, two or more light sources of which oscillation wavelengths are different may be used, and a hologram may be recorded from the original master plate onto the volume hologram using two or more different wavelengths.

However, when two or more laser light source of which oscillation wavelengths are different are used, the size of the recording apparatus of the hologram is increased, and it is necessary to have a recording material supporting two or more recording wavelengths. When the hologram is used as the original master plate, the amount of exposure and the adjustment of diffraction efficiency are difficult in the production of the original master plate, and it is necessary to carefully select the wavelength of the laser light source and align the laser light. Therefore, as compared with a case where recording is done with a single wavelength, the manufacturing step of the volume hologram becomes complicated.

It is complicated to produce an original master plate using two or more laser light sources of which oscillation wavelengths are different. For this reason, the method of using two or more laser light sources of which oscillation wavelengths are different is not suitable for manufacturing of the volume hologram having one or more regions in which the wavelength spectrums of diffracted lights are different, and more particularly, it is not suitable for small lot production of many products. Therefore, because of mass production, the figure pattern of the same hologram is commonly used by many products, and this makes it less likely to improve the security of genuineness determination of the volume hologram.

Accordingly, the inventors of the present application have repeatedly, industriously studied this issue, and as a result, the inventors of the present application have found a volume hologram and a manufacturing method thereof performing recording of a hologram using a single wavelength but having one or more regions in which the wavelength spectrums of diffracted lights are different.

[Configuration of Volume Hologram]

According to an embodiment, the volume hologram includes one or more regions in which wavelength spectrums of diffracted lights are different. Therefore, even if a person tries to illegally contact-copy the volume hologram using laser light of a single wavelength, illegally copied hologram includes a region of which reproduction is incomplete. More specifically, the function of copy protection of the volume hologram can be improved.

In an embodiment, the volume hologram includes one or more regions in which wavelength spectrums of diffracted lights are different. More preferably, when white light is emitted from a predetermined angle, a color difference between adjacent regions is 0.5 or more. More preferably, the absolute value of difference of the thickness in the region in which the wavelength spectrum of diffracted light is different and the thickness in the remaining region is within a range of more than 0 but 30% or less as compared with the thickness in the remaining region. According to the present technique, it is possible to make it less conspicuous that the volume hologram has a region in which the wavelength spectrums of diffracted lights are different. Whether the volume hologram includes a region in which the wavelength spectrums of diffracted lights are different can be determined from measurement using a spectrophotometer. More specifically, covert technical element, which is difficult to be determined without the use of a device, can also be given to the volume hologram.

Color difference referred to herein in this specification is color difference in CIE1976L*a*b* color system. CIE1976L*a*b* color system is a color space defined by Commission Internationale de l'Eclairage (CIE), and is a typical Uniform Color Space (UCS). Therefore, CIE1976L*a*b* color system has an advantage in that it has uniform color difference property and can uniformly measure the color difference. Hereinafter, the color difference in CIE1976L*a*b* color system will be described as color difference ΔE*_{ab} as necessary. CIE1976L*a*b* color system is described as L*a*b* color system as necessary.

In L*a*b* color system, if (L*, a*, b*) of the first color and the second color are known, color difference ΔE*_{ab} is represented by Euclidean distance between the first color and the second color (L*, a*, b*). More specifically, when (L*, a*, b*) of the first color and the second color (L*, a*, b*) are (L*₁, a*₁, b*₁), (L*₂, a*₂ᵣ b*₂), respectively, the color difference ΔE*_{ab} is defined by the following expression (1).

[Math 1]

ΔE*_{ab}={square root over ((L₂*−L₁*)²+(a₂*−a₁*)²+(b₂*−b₁*)²))} (1)

As can be understood from the expression (1), the color difference ΔE*_{ab} is obtained by adding a square of difference of L* of two colors, a square of difference of a* of two colors, and a square of difference of b* of two colors, and obtaining a square root of the added result. It should be noted that L* is called psychometric lightness, and is within a range of 0≦L*≦100. L*=0 means black and, L*=100 means diffusion color of white. a* and b* are called psychometric chroma coordinates, and the ranges of values of a* and b* are different according to the color space of the origin of conversion. a and b represent a position corresponding to hue and saturation in color space.

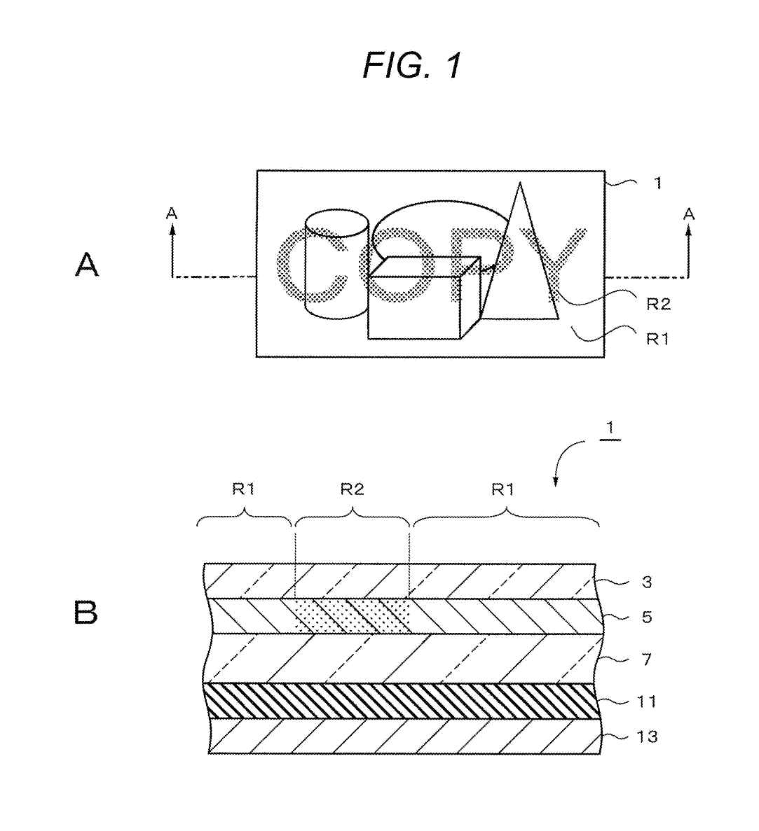

FIG. 1A is a top view illustrating an example of configuration of a volume hologram according to an embodiment of the present disclosure. As illustrated in FIG. 1A, for example, a volume hologram 1 is recorded, in a holographic manner, with image information reproduced from an original master plate and the like.

For example, an observer seeing the volume hologram 1 can observe the hologram recorded in the volume hologram 1 under illumination such as fluorescent lamp. At this occasion, for example, when the hologram of the original master plate is recorded to the volume hologram 1 by green laser in which the wavelength is about 532 nm, the color perceived from the reproduced image of the volume hologram 1 is green. This is because the wavelength corresponding to the peak of diffraction efficiency of the volume hologram 1 is about 532 nm which is substantially the same as the recording wavelength.

In an embodiment, the volume hologram 1 has a region R2 in which the wavelength spectrum of the diffracted light is different from the wavelength spectrum of the diffracted light in the other region. More specifically, for example, volume hologram 1 has not only the region R1 in which the wavelength of the peak of the diffraction efficiency is about 532 nm which is substantially the same as the recording wavelength but also a region R2 in which the wavelength of the peak of the diffraction efficiency is different from that of the region R1. In the example of configuration as illustrated in FIG. 1A, the region R2 is provided in the shape of characters of “COPY”. In FIG. 1A, the region R2 is shown as a shaded region.

It should be noted that the shape of the region R2 and the position and the size occupied thereby with respect to the entire volume hologram 1 are set as any shape, position, and size, and are not limited to the shape of the characters. For example, the shape of the region R2 may be dots, stripes, lattice, other patterns, circular shape, polygonal shape, symbol-like shape, mark-like shape, bar-code shape, or a combination thereof. In addition to the region R2, multiple regions in which the wavelength spectrum of the diffracted light is different from the wavelength spectrum of the diffracted light of the region R1 may be provided. At this occasion, the wavelength of the peak of the diffraction efficiency in each region is preferably configured to be different from each other. This is because the function of copy protection of the volume hologram 1 can be improved.

In this case, the wavelength spectrum of the diffracted light as referred to in this specification is considered to mean a wavelength spectrum obtained by measuring the diffraction efficiency of the hologram (spectrum characteristics). The diffraction efficiency of the hologram as referred to in this specification is measured according to the following method.

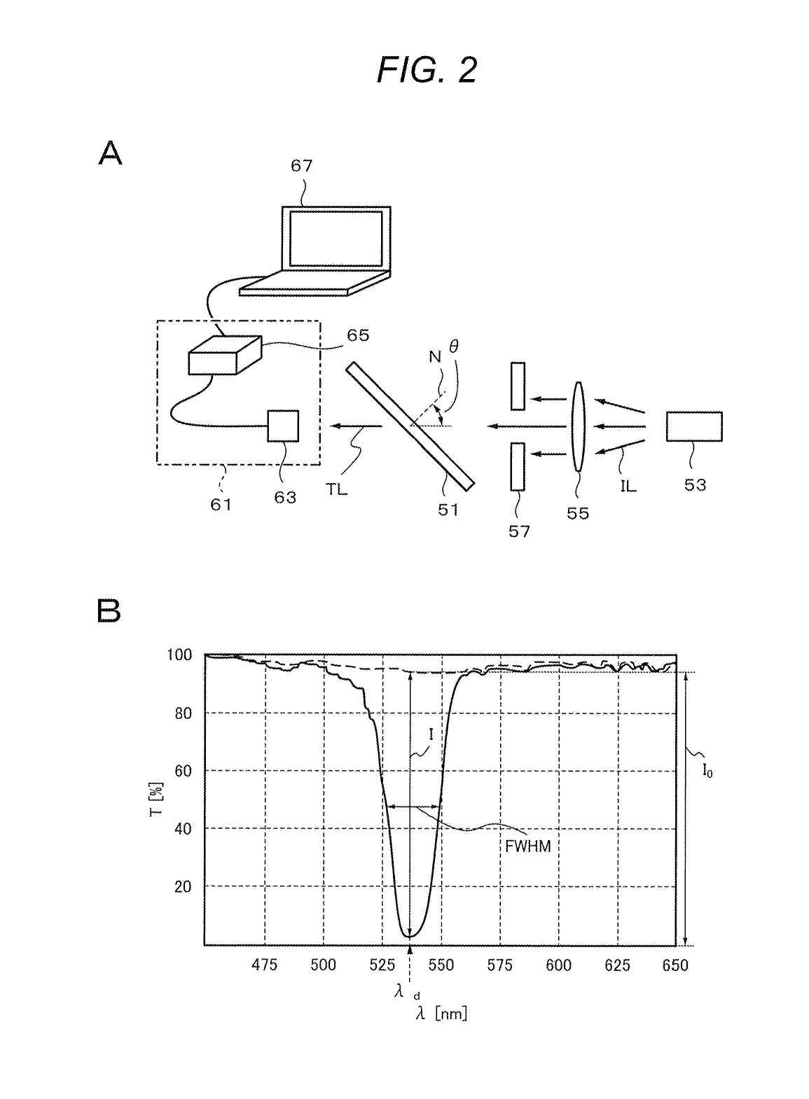

FIG. 2A is a schematic diagram for explaining a measurement method of spectrum characteristics for a recorded photosensitive material. FIG. 2B is a figure illustrating an example of measurement result of spectrum characteristics. As illustrated in FIG. 2A, in the measurement of the spectrum characteristics of the recorded photosensitive material, the following items are arranged in order: a light source 53, a collimator lens 55, a diaphragm 57, a measurement substrate 51, and a detection device 63. A spectrophotometer 61 is constituted by a detection device 63 and a spectrometer 65, and the output from the spectrophotometer 61 is sent to an analysis computer 67. Hereinafter shown is a spectrophotometer and a light source used in this measurement.

Spectrophotometer . . . OCEAN OPTICS USB4000

Light source (white light source) . . . halogen lamp (Y: 96.0, x: 0.4508, y: 0.4075 on Yxy chromaticity diagram)

For example, the measurement substrate 51 of which spectrum characteristics are to be measured is a recorded volume hologram. The measurement substrate 51 is arranged such that the angle θ of the normal line N on its surface and the optical axis of the light incident thereupon from the light source 53 is a predetermined angle. The predetermined angle is, for example, 45°.

The illumination light IL from the light source 53 is incident upon the measurement substrate 51 via the collimator lens 55 and the diaphragm 57. Some of the illumination light IL incident upon the measurement substrate 51 is diffracted by the measurement substrate 51, and the remaining light TL (transmitted light TL) passes through the measurement substrate 51, and reaches the detection device 63. The transmitted light TL from the measurement substrate 51 is incident upon the detection device 63, and the analysis computer 67 calculates a transmittance T [%] for each wavelength of light incident upon the measurement substrate 51.

FIG. 2B is a graph in which the horizontal axis denotes a wavelength λ [nm] of transmitted light, and the vertical axis denotes a transmittance T [%]. In FIG. 2B, on the measurement substrate 51, the transmittance in a portion where white is printed is denoted by a solid line, and the transmittance in a portion where black is printed is denoted by a broken line. It should be noted that FWHM as illustrated in FIG. 2B means full width at half maximum of diffracted light intensity.

The diffraction efficiency is defined by the following expression (2).

(diffraction efficiency)=(I/I₀)×100[%] (2)

In this case, I° as illustrated in FIG. 2B is transmittance in a portion where black is printed at a certain wavelength λ_{d}. I as illustrated in FIG. 2B is difference between the transmittance in a portion where black is printed and the transmittance in a portion where white is printed at the wavelength λ_{d}.

FIG. 1B is a schematic view illustrating a portion of A-A cross section of a volume hologram as illustrated in FIG. 1A. As illustrated in FIG. 1B, the volume hologram 1 according to an embodiment includes a hologram recording layer 5 made of a hologram photosensitive material such as photopolymer. In the example of configuration as illustrated in FIG. 1B, the volume hologram 1 includes a protection layer 3 at a side of the observer who sees the hologram recording layer 5 (upper side in FIG. 1B). In the example of configuration as illustrated in FIG. 1B, the volume hologram 1 includes a base material layer 7, an adhesive layer 11, and a separator 13 at the side opposite to the observer who sees the hologram recording layer 5. Hereinafter, the hologram recording layer 5, the protection layer 3, the base material layer 7, and the adhesive layer 11 will be explained in order.

(Hologram Recording Layer)

The hologram recording layer 5 is a layer in which the volume hologram is recorded. Examples of materials constituting the hologram recording layer 5 include photosensitive materials such as photopolymerizable resin material, photocrosslinkable resin material, silver salt material, and dichromated gelatin. For example, the photopolymerizable resin material is preferably light-cured photopolymer because it is not necessary to perform any special developing processing after exposure.

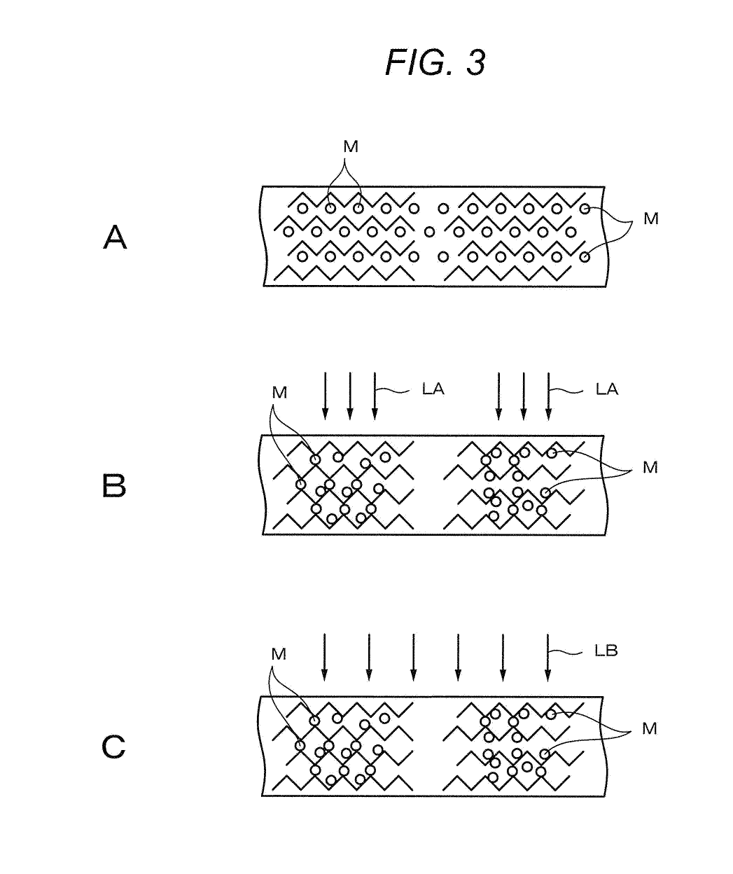

FIGS. 3A to 3C are schematic diagrams illustrating exposure process for a light-cured photopolymer. In the initial state, as illustrated in FIG. 3A, the light-cured photopolymer is such that monomers M are uniformly dispersed in a matrix polymer. In contrast, as illustrated in FIG. 3B, when light LA having a power of about 10 to 400 mJ/cm² is emitted, the monomers M are polymerized in the exposed portion. Then, as the polymerization proceeds, the monomers M move from therearound, and the density of the monomers M become different depending on the position, and accordingly, the refractive index modulation occurs. Thereafter, as illustrated in FIG. 3C, ultraviolet ray or visible light LB having a power of about 1000 mJ/cm² is emitted on the entire surface, whereby the polymerization of the monomers M is completed. As described above, the refractive index of the light-cured photopolymer becomes different in accordance with incident light, and therefore the interference pattern generated by interference of the reference light and the object light may be recorded as change of the refractive index.

The volume hologram 1 using the light-cured photopolymer need to be subjected to any special developing processing after exposure. Therefore, by using the light-cured photopolymer in the hologram recording layer 5, the configuration of a manufacturing apparatus for manufacturing the volume hologram 1 can be simplified.

As explained later, in an embodiment, at least a portion of the hologram recording layer 5 is pressed. Pressing of at least a portion of the hologram recording layer 5 may be performed at the same time as emission of the light LB for completing polymerization of the monomers M, for example. By pressing at least a portion of the hologram recording layer 5 and emitting light having a predetermined power onto the entire surface of the hologram recording layer 5, the hologram recording layer 5 is cured along with the change. This change is, for example, a change of reduction of clearness of the interference pattern recorded onto a target of copy when contact copy is performed using the volume hologram 1 as the master plate.

Pressing of at least a portion of the hologram recording layer 5 may not be performed at the same time as emission of the light LB for completing polymerization of the monomers M as long as it is after information is recorded to the hologram recording layer 5. For example, at least a portion of the hologram recording layer 5 may be pressed before or after the light LB for completing polymerization of the monomers M is emitted. By pressing at least a portion of the hologram recording layer 5, the region R2 can be formed in which the wavelength spectrum of the diffracted light is different from that of the region R1. In FIG. 1B, the region R2 is shown as a shaded region.

(Protection Layer)

The protection layer 3 is a transparent protective film made of a resin material, for example. The protection layer 3 is provided to, e.g., prevent damage and charging, forming the film shape, and stabilizing the hologram shape. An example of resin material constituting the protection layer 3 may be, for example, ultraviolet ray cured resin, but is not limited thereto. The material constituting the protection layer 3 preferably has sufficiently low degree of birefringence. Moreover, the optical refractive index of the protection layer 3 is preferably not greatly different from the optical refractive index of the hologram recording layer 5. This is because the protection layer 3 does not become obstacle when the hologram is observed.

(Base Material Layer)

At the opposite side to the observer who sees the hologram recording layer 5, for example, the base material layer 7 is provided. The base material layer 7 is provided to protect and support the hologram recording layer 5. An example of material constituting the base material layer 7 may be a resin material. Examples of resin materials include polyethylene terephthalate, polycarbonate, polymethyl methacrylate, polyester, and polyimide.

The base material layer 7 may not be necessarily transparent, but the base material layer 7 is preferably transparent. This is because, when the hologram recorded in the original master plate is recorded to the hologram recording layer 5, the laser light can be emitted onto the hologram recording layer 5 via the base material layer 7. In addition, this is because, during exposure for polymerization of photopolymer, for example, ultraviolet ray and the like can be emitted onto the hologram recording layer 5 via the base material layer 7.

(Adhesive Layer)

In the example of configuration as illustrated in FIG. 1B, the adhesive layer 11 is provided adjacent to the base material layer 7 at the opposite side to the observer who sees the hologram recording layer 5, and the separator 13 is provided adjacent to the adhesive layer 11. The separator 13 is, for example, release film made of resin such as polyethylene terephthalate. The adhesive layer 11 and the separator 13 are provided as necessary. When the adhesive layer 11 and the separator 13 are provided, the volume hologram 1 can be easily attached to a body such as a product by means of the adhesive layer 11.

Examples of materials constituting the adhesive layer 11 include acrylic resin, acrylic acid ester resin, copolymers thereof, styrene butadiene copolymer, natural rubber, casein, gelatin, rosin ester, terpene resins, phenolic resins, styrene resins, chroman-indene resins, polyvinyl ether, and silicone resin. Alpha cyanoacrylate, silicone, maleimide, styrol, polyolefin, resorcinol, polyvinyl ether, silicone adhesive agents made be used as the adhesive layer 11. The thickness of the adhesive layer 11 is preferably between 4 μm to 300 μm, inclusive.

The adhesive layer 11 may be thermoplastic hot melt adhesive based on Polyamide resin, polyolefin resins, polyester, olefin-modified, reactive urethane, ethylene-vinylacetate copolymer, and the like. In this case, the volume hologram 1 can be configured as so-called transfer foil.

When the base material layer 7 is transparent, the adhesive layer 11 is preferably black. The reason why the adhesive layer 11 serving as the background of the hologram is black is because when it is attached to a product, this enhances the contrast of the hologram, which makes it easy to see information recorded in the volume hologram 1. In this case, “black” means such range that OD (OPTICAL DENSITY) is 1.0 or more, the brightness in L*a*b* color system defined by JIS Z 8729 is 30 or less, or the average reflectance at visible light region wavelength of 400 to 750 nm is 20% or less. When the OD, the brightness, or the average reflectance are within the range described above, it is easy to observe the hologram, which is preferable. It is to be understood that the base material layer 7 may also be black.

The adhesive force of the adhesive layer 11 is preferably stronger as compared with the self-sustaining force or breaking strength of the hologram recording layer 5. When somebody tries to perform illegal contact copy using the volume hologram 1 as the master plate, and tries to remove the volume hologram 1 from the body to which it is attached, the hologram recording layer 5 is destroyed before the volume hologram 1 is removed from the body. In this manner, illegal contact copy using the volume hologram 1 as the master plate can be prevented.

[Copy Protection]

Now, the function of copy protection of the volume hologram 1 will be explained.

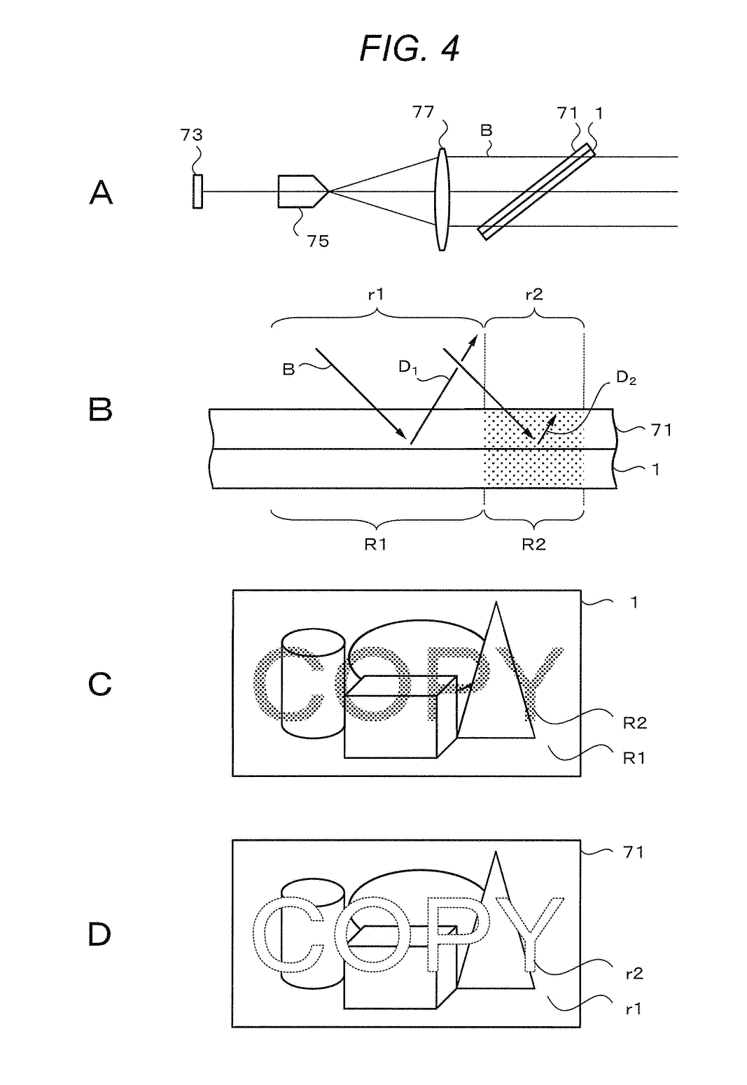

FIG. 4A is a schematic view used to explain contact copy. FIG. 4B is a schematic view used to explain recording of an interference pattern when illegal contact copy is performed using the volume hologram of the present disclosure as a master plate. FIG. 4C is a top view schematically illustrating a reproduced image reproduced from the volume hologram of the present disclosure. FIG. 4D is a top view schematically illustrating a reproduced image reproduced from a recording medium made by illegal contact copy using the volume hologram of the present disclosure as a master plate.

In illegal contact copy using the volume hologram 1 as the master plate, for example, as illustrated in FIG. 4A, a reproduction recording medium 71 is brought into close contact with the volume hologram 1, or is brought into close contact therewith with a refractive index adjusting liquid and the like interposed therebetween. The reproduction recording medium 71 is, for example, a recording medium formed with a hologram recording layer on a transparent base material, and the hologram recording layer of the reproduction recording medium 71 is brought into close contact with the protection layer 3 of the volume hologram 1. Further, via the space filter 75 and the collimator lens 77, the laser light from the laser light source 73 is emitted onto the volume hologram 1 and the reproduction recording medium 71.

With the emission of the laser light, information recorded in the volume hologram 1 is reproduced. By reproducing information recorded in the volume hologram 1, an interference pattern formed by the diffracted light (reproduction light) from the volume hologram 1 and the incident laser light is recorded to the reproduction recording medium 71. Therefore, information recorded in the volume hologram 1 is reproduced in the reproduction recording medium 71.

In this case, the volume hologram 1 has a region R2 in which the wavelength spectrum of the diffracted light is different from the wavelength spectrum of the diffracted light in the other region. More specifically, for example, volume hologram 1 has not only the region R1 in which the wavelength of the peak of the diffraction efficiency is substantially the same as the recording wavelength but also a region R2 in which the wavelength of the peak of the diffraction efficiency is different from that of the region R1. In other words, the wavelength of the peak of the diffraction efficiency of the volume hologram 1 is different depending on the region R1 and the region R2.

FIG. 4B is a cross sectional view enlarging and schematically illustrating a portion of the volume hologram 1 and the reproduction recording medium 71 as illustrated in FIG. 4A. During illegal contact copy, the wavelength which is as close as possible to the recording wavelength of the volume hologram 1 is selected as the wavelength of the laser light. Therefore, with respect to the emission B of the laser light, the intensity of the diffracted light D₁ from the region R1 of the volume hologram 1 is higher, and the interference pattern recorded in the reproduction recording medium 71 is brighter. More specifically, in the reproduction recording medium 71, information recorded in the region R1 of the volume hologram 1 is reproduced in the region r1 corresponding to the region R1 of the volume hologram 1.

On the other hand, with respect to the emission B of the laser light, the intensity of the diffracted light D₂ diffracted by the region R2 in the same angle as the diffracted light D₁ is less than the intensity of the diffracted light D₁ from the region R1. This is because the wavelength of the peak of the diffraction efficiency of the region R2 of the volume hologram 1 is deviated from the wavelength of the peak of the diffraction efficiency of the region R1. Therefore, the interference pattern recorded in the reproduction recording medium 71 becomes less bright.

For example, suppose that the volume hologram 1 recorded with the image information as illustrated in FIG. 4C, for example, is contact-copied using laser light having a wavelength close to the recording wavelength. Then, in the reproduction recording medium 71, information recorded in the region R2 of the volume hologram 1 is incompletely copied onto the region R2 corresponding to the region R2 of the volume hologram 1. As described above, in the region R1 of the volume hologram 1 and the region R2 of the volume hologram 1, the intensities of the diffracted lights contributing to the copying process are different, and as a result, the degree of clearness of the interference pattern recorded in the reproduction recording medium 71 becomes different.

When white light is emitted from a predetermined angle, the color difference ΔE*_{ab} between the region R1 and the region R2 is preferably 0.5 or higher. In other words, in the step of pressing of the hologram recording layer explained later, the change of the wavelength spectrum of the diffracted light is preferably 0.5 or higher in terms of color difference between the pressed region and the not pressed region. This is because, when the color difference ΔE*_{ab} between different regions is 0.5 or higher, the function of copy protection against contact copy of the volume hologram 1 can be provided. From the viewpoint of reducing the degree of clearness of the interference pattern recorded in the reproduction recording medium used for illegal contact copy, the upper limit of the color difference ΔE*_{ab} is not particularly limited.

It should be noted that evaluation references of values of color differences are set by National Bureau of Standards of the United States. Hereinafter shown is correspondence between description about the degree of color difference and the magnitude of color difference ΔE*_{ab}. ΔE*_{ab} shown below is the value represented by NBS (National Bureau of Standards) unit.

Extremely slightly different (trace) ΔE*_{ab}: 0 to 0.5

Slightly different (slight) ΔE*_{ab}: 0.5 to 1.5

Noticeably different (noticeable) ΔE*_{ab}: 1.5 to 3.0

Significantly different (appreciable) ΔE*_{ab}: 3.0 to 6.0

Extremely significantly different (much) ΔE*_{ab}: 6.0 to 12.0

Different color system (very much) ΔE*_{ab}: 12.0 or more

(The above values are evaluations concerning printed materials and display screens.)

In a case of hologram, perceived color and brightness may become different even in the same portion, depending on the wavelength component of the light source, illumination angle, observation angle, and the like, but as long as the color difference ΔE*_{ab} is 1.5 or more, the influence of the measurement error in the measurement of spectrum characteristics can be reduced to a sufficiently low level.

When the range of the color difference ΔE*_{ab} is set at 0.5 to 6, inclusive, this makes it possible to be less likely to have an observer notice the existence of the region R2 in the volume hologram 1 at a glance under white light. In FIG. 4C, for the sake of explanation, the region R2 is shown as a shaded region, but when the color difference ΔE*_{ab} is within a range of 0.5 to 6, inclusive, the existence of the region R2 arranged in the volume hologram 1 is less likely to be noticed at a glance, which is preferable.

When the region R1 and the region R2 provided in the volume hologram 1 are configured to be unnoticeable at a glance, a person who tries illegal contact copy may try to perform contact copy with a single wavelength. However, when the volume hologram 1 is contact-copied with a single wavelength, information reproduced to the region r2 of the reproduction recording medium 71 becomes unclear as described above. More specifically, as illustrated in FIG. 4D, in information recorded in the reproduction recording medium 71, information corresponding to the region r2 is lost or becomes unclear. In FIG. 4D, for the sake of explanation, the region r2 is indicated as a region enclosed by a broken line.

On the other hand, when the color difference ΔE*_{ab} is more than 6, and an observer observes the volume hologram 1 under white light, the observer may recognize that the color perceived in the region R2 is different from the color perceived in the region R1. From the viewpoint of confirming the hologram recorded in the volume hologram 1, preferably, the region R2 in the volume hologram 1 does not hinder observation of the hologram. Even when color difference ΔE*_{ab} is more than 6, the ratio of the region R2 occupied with respect to the entire volume hologram 1 is reduced, so that it makes it less conspicuous that the region R2 is arranged in the volume hologram 1. For example, depending on the size of the region R2 occupied with respect to the entire surface of the volume hologram 1 and the position of the region R2 with respect to the entire surface of the volume hologram 1, the color difference ΔE*_{ab} of diffracted lights between the region R1 and the region R2 may be configured to be more than 6.

The color difference ΔE*_{ab} of diffracted lights between the region R1 and the region R2 may be 60 or more. When the color difference ΔE*_{ab} is 60 or more, this is preferable because the color of the region R2 and the color of the region R1 are perceived to be more different when the volume hologram 1 is observed under white light. At this occasion, from the viewpoint of suppressing deterioration of information recorded in the volume hologram 1, the color difference ΔE*_{ab} is preferably 80 or less. This is because, when the color difference ΔE*_{ab} is 80 or less, this can suppress deterioration of the reproduced image due to extremely large change in the portion pressed in the step of pressing the hologram recording layer explained later. Even when color difference ΔE*_{ab} is equal to or more than 60, the ratio of the region R2 occupied with respect to the entire volume hologram 1 is reduced, so that it makes it less conspicuous that the region R2 is arranged in the volume hologram 1.

When reproduction is performed using the volume hologram of the present disclosure as the master plate, for example, a pattern in which the region R2 is formed appears in the reproduced hologram. Therefore, information observed in the reproduced product which is made by illegal contact copy is different from information observed in the genuine volume hologram 1. The region R2 provided in the volume hologram 1 gives the effect of watermark to the reproduced hologram. Accordingly, this enables finding whether a hologram is a copied item or not at a glance, and enhances the security of genuineness determination of the volume hologram.

Further, in the present disclosure, even if a person who tries illegal contact copy notices that the volume hologram 1 includes the region R1 and the region R2, this does not mean that the volume hologram 1 immediately loses the function of copy protection.

For example, suppose that the volume hologram 1 includes regions in which the wavelength spectrums of diffracted lights are different. In this case, in order to reproduce information recorded in the volume hologram 1 including shifts of the wavelength of the peak of the diffraction efficiency between multiple regions, it is necessary to perform multiple exposure. However, in general, in the multiple exposure of a hologram using two or more laser light sources of which oscillation wavelengths are different, it is difficult to adjust the diffraction efficiency and the amount of exposure between wavelengths. Further, in the present disclosure, when contact copy is performed using multiple laser light sources of which oscillation wavelengths are different, but an image in a region is reproduced with a certain wavelength, then, the image of the other region is inadvertently reproduced even with a weak level, and it is difficult to perform exposure corresponding to each wavelength.

As described above, in the present disclosure, it is extremely difficult to reproduce information observed in the genuine volume hologram 1 using the illegal contact copy. Therefore, in the present disclosure, the function of copy protection against contact copy of a volume hologram can be improved.

[Manufacturing Method of the Volume Hologram]

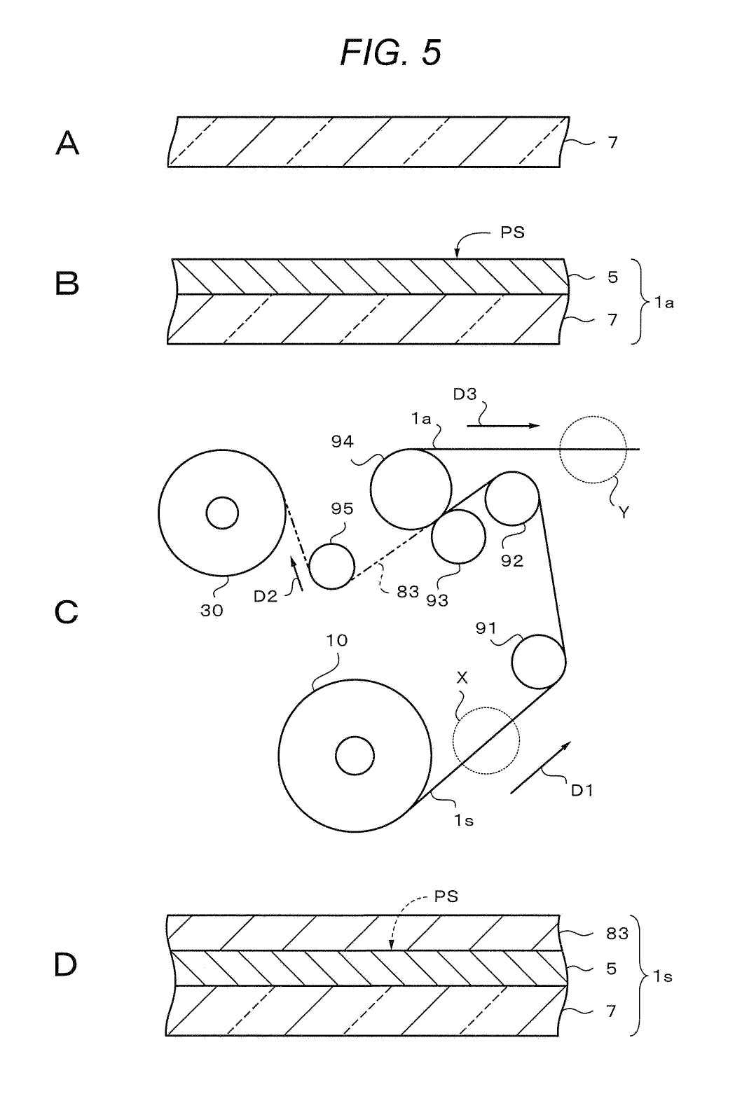

Hereinafter, each step of a manufacturing method of the volume hologram according to an embodiment will be explained with reference to FIGS. 5 to 8. It should be noted that because of the restriction of the size of the drawings, a series of manufacturing steps is divided into multiple drawings, but in view of productivity, process of some or all of the manufacturing method may be done by roll to roll.

In an embodiment, a manufacturing step of a volume hologram includes a step of hologram recording for recording information to a hologram recording layer and a pressing step of the hologram recording layer for pressing at least a portion of the hologram recording layer recorded with the information. In the step of pressing the hologram recording layer, the hologram recording layer recorded with information may change.

In an embodiment, at least a portion of the hologram recording layer 5 is pressed. Pressing of at least a portion of the hologram recording layer 5 may be performed at the same time as emission of the light LB for completing polymerization of the monomers M, for example. Alternatively, pressing of at least a portion of the hologram recording layer 5 may be performed before or after the emission of the light LB for completing polymerization of the monomers M. At least a portion of the volume hologram is pressed, and change of property occurs in the photopolymer layer recorded with the interference pattern. For this reason, in the hologram recording layer recorded with information, the following changes occur: change of reduction of the degree of clearness of the interference pattern recorded to a target of copy, change of the refractive index in the thickness direction, change of the interference pattern, change of the thickness, or change of the wavelength spectrum of the diffracted light when white light is emitted from a predetermined angle. In the hologram recording layer, a region where change of property occurs in the photopolymer layer constitutes the region R2 of the volume hologram. More specifically, by partially pressing the photosensitive material recorded with the hologram, the wavelength spectrum of the diffracted light is partially changed in the photosensitive material, whereby the wavelength spectrum of the diffracted light can be deviated.

(Forming Hologram Recording Layer)

First, as illustrated in FIG. 5A, for example, a sheet-like or film-like base material layer 7 is formed from the resin material. Examples of forming methods include melt extrusion method and injection molding method but are not limited thereto.

Subsequently, as illustrated in FIG. 5B, for example, the hologram recording layer 5 is formed on a principal surface of the base material layer 7 by applying a photosensitive material such as light-cured photopolymer. Examples of application of light-cured photopolymer include die coating method, micro gravure coating method, wire bar coating method, direct gravure coating method, dip coating method, spray coating method, reverse roll coating method, curtain coating method, comma coating method, knife coating method, and spin coating method.

As necessary, the applied light-cured photopolymer is dried by far-infrared ray and hot air. Drying process is done in order to prevent the applied light-cured photopolymer from dripping. The dried light-cured photopolymer is, for example, not-yet cured or half cured state (this state may be hereinafter referred to as wet state as necessary). In the explanation below, a laminated body of the base material layer 7 and the hologram recording layer 5 will be referred to as a laminated body 1a. The laminated body 1a has, as illustrated in FIG. 5B, an exposure surface PS

As illustrated in FIG. 5C, for example, a laminated body 1s may be provided in which the base material layer 7, the hologram recording layer 5, and the separator 83 are laminated in advance. In the example of configuration as illustrated in FIG. 5C, the laminated body 1s fed from the supply roll 10 in the direction of arrow D1. FIG. 5D shows a cross section schematic diagram illustrating the laminated body 1s taken along an X portion indicated by a broken line in FIG. 5C. The laminated body 1s may be provided in the state of sheet instead of the state of wrapped roll.

The laminated body 1s fed from the supply roll 10 runs on rollers 91, 92 in order, and is introduced into between a roller 93 and a roller 94. The rollers 91, 92 are configured to give tension to the laminated body 1s using a torsion coil spring and the like in order to prevent the laminated body 1s from becoming loose.

At this occasion, the separator 83 is separated from the laminated body 1s. The separated separator 83 passes on the roller 95, and thereafter, runs in the direction of arrow D2, and is wrapped around a wrapping roll 30. It should be noted that the laminated body provided from the supply roll may be configured not to include the separator 83. In this case, the roller 95 and the wrapping roll 30 may be omitted.

On the other hand, the laminated body from which the separator 83 is separated is wrapped around the peripheral surface of the roller 94, and is caused to run in the direction of arrow D3. The laminated body 1s from which the separator 83 is separated becomes the laminated body 1a of the base material layer 7 and the hologram recording layer 5 having the exposure surface PS. The cross section schematic diagram as illustrated in FIG. 5B corresponds to the cross section schematic diagram illustrating the laminated body taken along Y portion as illustrated by a broken line in FIG. 5C. The laminated body 1a that runs in the direction of arrow D3 is, for example, introduced into multiple apparatuses 100 in order to record holograms.

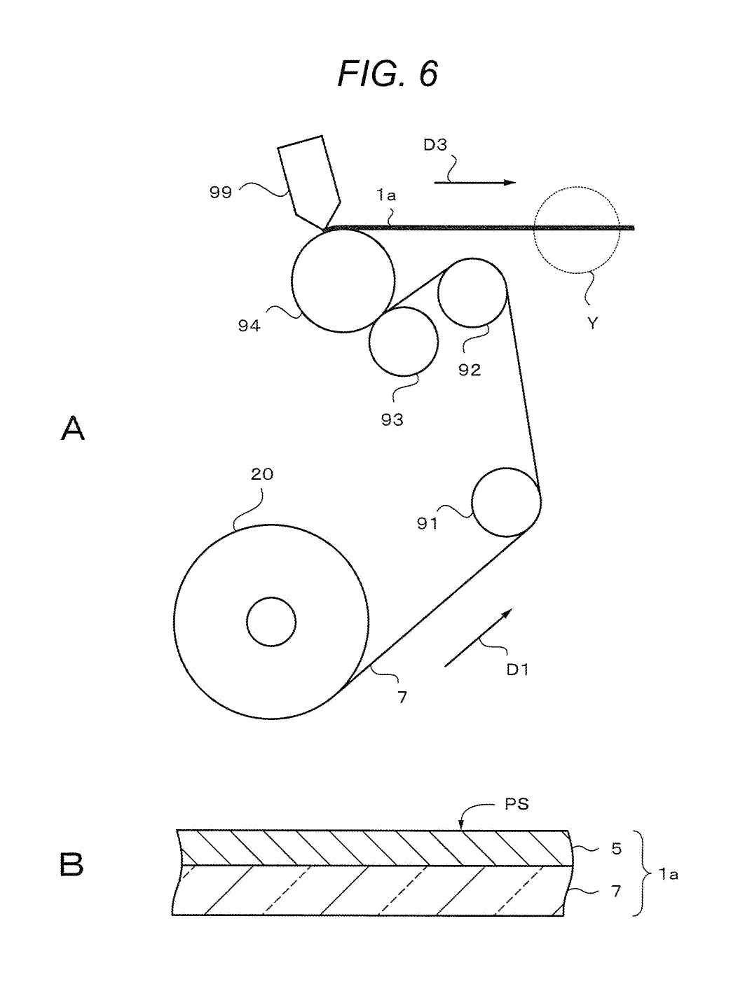

It should be noted that forming of the hologram recording layer 5 may be done, as illustrated in FIG. 6A, by continuously applying a photosensitive material such as light-cured photopolymer onto a principal surface of the base material layer 7 provided from the supply roll 20. For example, as illustrated in FIG. 6A, the base material layer 7 is fed from the supply roll 20 in the direction of arrow D1. The base material layer 7 is provided, for example, in the state of a roll wrapped around the supply roll 20 like a roll or in the state of sheet.

The base material layer 7 fed from the supply roll 20 runs on the rollers 91, 92 in order, and passes between the roller 93 and the roller 94, and is wrapped around the peripheral surface of the roller 94. The rollers 91, 92 are configured to give tension to the base material layer 7 using a torsion coil spring and the like in order to prevent the base material layer 7 from becoming loose.

Subsequently, a photosensitive material such as light-cured photopolymer is applied to the base material layer 7 wrapped around the peripheral surface of the roller 94 using a slit die head 99 so as to make the film thickness uniform. As necessary, the applied light-cured photopolymer is dried by far-infrared ray and hot air. After the drying process, the thickness of the hologram recording layer 5 (applied light-cured photopolymer) may be measured by a film thickness measurement apparatus, and the width of opening and opening/closing of the slit of the slit die head 99 may be controlled so that the thickness of the applied light-cured photopolymer is at a constant level.

The base material layer 7 having light-cured photopolymer on a principal surface thereof constitutes the laminated body 1a of the base material layer 7 and the hologram recording layer 5 having the exposure surface PS and runs in the direction of arrow D3. The cross section schematic diagram as illustrated in FIG. 6B corresponds to the cross section schematic diagram illustrating the laminated body 1a taken along Y portion as illustrated by a broken line in FIG. 6A. In the example of configuration as illustrated in FIG. 6A, like the example of configuration as illustrated in FIG. 5C, the laminated body 1a that runs in the direction of arrow D3 is, for example, introduced into multiple apparatuses 100 in order to record holograms.

(Recording Hologram)

Subsequently, in the hologram recording layer 5, for example, a hologram recorded to a hologram master plate 105 is reproduced.

The laminated body 1a is, for example, introduced into multiple apparatuses 100 in order to record holograms. In the multiple apparatuses 100, the hologram recording layer 5 and the hologram master plate 105 are brought into close contact with each other while the laminated body 1a is stopped, and recording laser light is emitted onto the hologram recording layer 5 and the hologram master plate 105. The hologram master plate 105 is configured to include, for example, a recording hologram layer 105a which is sandwiched between glass plates 105b, 105c. The interference pattern of the diffracted light from the hologram master plate 105 and recording laser light is recorded to the hologram recording layer 5 as the change of the refractive index. As described above, the hologram of the hologram master plate 105 is copied to the hologram recording layer 5 as the hologram.

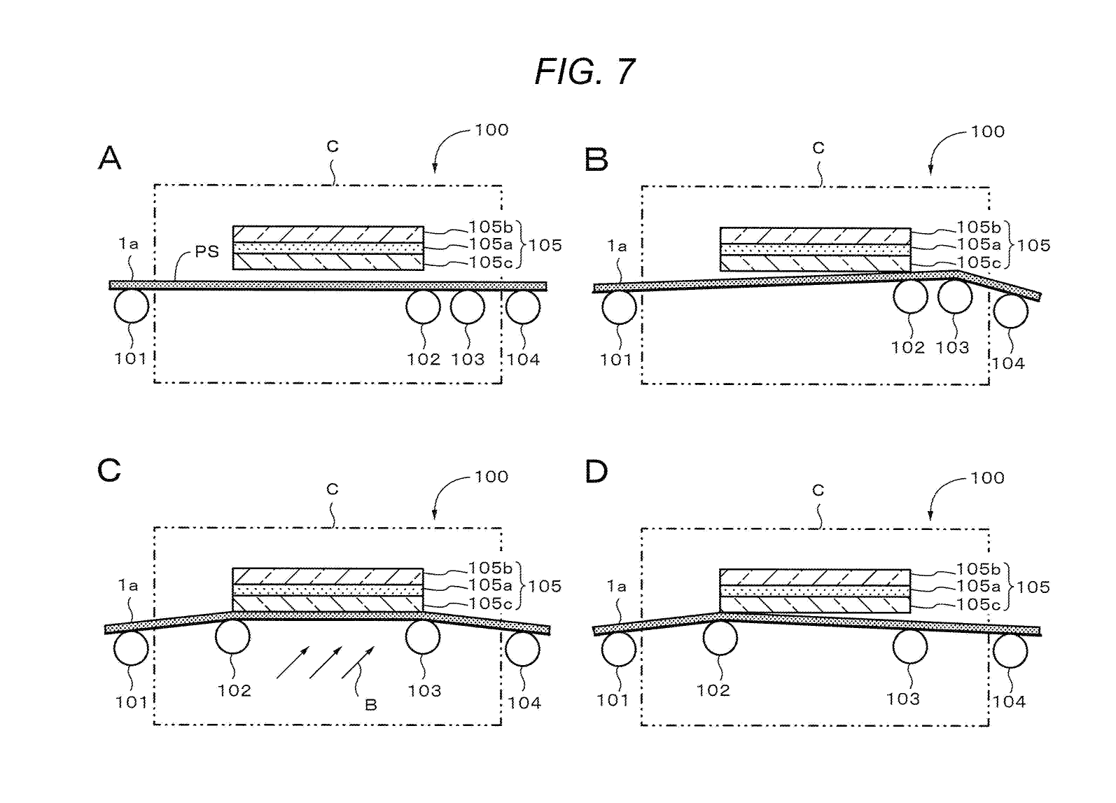

As illustrated in FIGS. 7A to 7D, the multiple apparatuses 100 include a chamber C (indicated by chain double-dashed line) for sealing the reproduction area including the hologram master plate 105 and rollers 101, 102, 103, 104 having peripheral widths equal to or more than the width of the hologram master plate 105. As necessary, a discharge apparatus may be provided to make the entire chamber C in a vacuum environment. The hologram master plate 105 is provided to face the exposure surface PS of the hologram recording layer 5 of the laminated body 1a. The rollers 101 to 104 are arranged at the side of the base material layer 7 with respect to the laminated body 1a. Among the rollers 101 to 104, the rollers 101 and 104 are arranged the entrance and the exit, respectively of the multiple apparatuses 100. The arrangement positions of the rollers 101 and 104 are fixed. Among the rollers 101 to 104, the rollers 102 and 103 are arranged in proximity to the exit of the laminated body 1a in the multiple apparatuses 100, and the roller 102 is located below the edge of the hologram master plate 105. The rollers 102 and 103 are configured to be slidable along the conveying direction of the laminated body 1a and the vertical direction.

As illustrated in FIG. 7A, when the laminated body 1a is introduced into the multiple apparatuses 100, the laminated body 1a is conveyed until the reproduction region of the laminated body 1a is positioned under the hologram master plate 105, and thereafter the laminated body 1a is once stopped. More specifically, the laminated body 1a is fed to the multiple apparatuses 100 in an intermittent manner. When the laminated body 1a is once stopped, the chamber C is evacuated as necessary. The reason why the chamber C is evacuated is that this prevents air from entering into between the hologram recording layer 5 of the laminated body 1a and the hologram master plate 105.

Subsequently, as illustrated in FIG. 7B, the rollers 102 and 103 are raised, and the laminated body 1a is raised. The rollers 102, 103 are raised to a position slight above the position where the laminated body 1a comes into contact with the edge of the hologram master plate 105. Therefore, the hologram recording layer 5 of the laminated body 1a is pressed against the edge of the hologram master plate 105.

Subsequently, as illustrated in FIG. 7C, the rollers 102 and 103 slide in substantially the horizontal direction toward the entrance of the multiple apparatuses 100. With the roller 103, the laminated body 1a is pressed against the exit side edge of the hologram master plate 105. The roller 102 slides to the edge at the entrance of the hologram master plate 105, so that the hologram recording layer 5 of the laminated body 1a is brought into pressurized contact with the hologram master plate 105. The light-cured photopolymer constituting the hologram recording layer 5 is in the wet state, and therefore, air is prevented from entering into between the hologram master plate 105 and the hologram recording layer 5, and the reproduction of the hologram can be stabilized. Moreover, it is not necessary to use adhering liquid separately, and therefore, this can eliminate the step of applying the adhering liquid at the interface between the hologram master plate 105 and the hologram recording layer 5 and brought them into close contact and removing the air from between the hologram master plate 105 and the hologram recording layer 5.

Subsequently, while the hologram master plate 105 and the hologram recording layer 5 are in close contact with each other, recording laser light is emitted from the lower side. With the emission B of the recording laser light, the hologram of the hologram master plate 105 is copied to the hologram recording layer 5. The wavelength of the recording laser light is the same as the one used during recording of the hologram of the hologram master plate 105.

Subsequently, as illustrated in FIG. 7D, the roller 103 is lowered, and the laminated body 1a is released from the hologram master plate 105 at the edge at the exit of the multiple apparatuses 100. When the chamber C is evacuated, the atmosphere is introduced before the roller 103 is lowered. When the laminated body 1a is released from the hologram master plate 105, the rollers 102 and 103 are returned back to the initial position as illustrated in FIG. 7A. Then, the laminated body 1a is conveyed until the subsequent recording region is located below the hologram master plate 105, and the same hologram recording step as above is performed.

(Pressing Step and Exposure Step)

Subsequently, in order to fix the recording image onto the hologram recording layer 5, post-processing is performed subsequent to recording of the hologram. With the post-processing to the laminated body 1a, the polymerization of the monomers M is completed. In an embodiment, in the post-processing of the laminated body 1a, at least a portion of the laminated body 1a is pressed when light of a predetermined power is emitted or before or after light of a predetermined power is emitted. With the emission of the light of the predetermined power, the degree of modulation of the refractive index of the light-cured photopolymer increases, and the recording image is fixed in the hologram recording layer 5. When at least a portion of the laminated body 1a is pressed, at least a portion of the hologram recording layer 5 is pressed. In the hologram recording layer 5, change of property occurs in a pressed portion or a not-pressed portion. The pressing of the hologram recording layer 5 includes, for example, a change of reduction of the degree of clearness of the interference pattern recorded onto a target of copy when contact copy is performed.

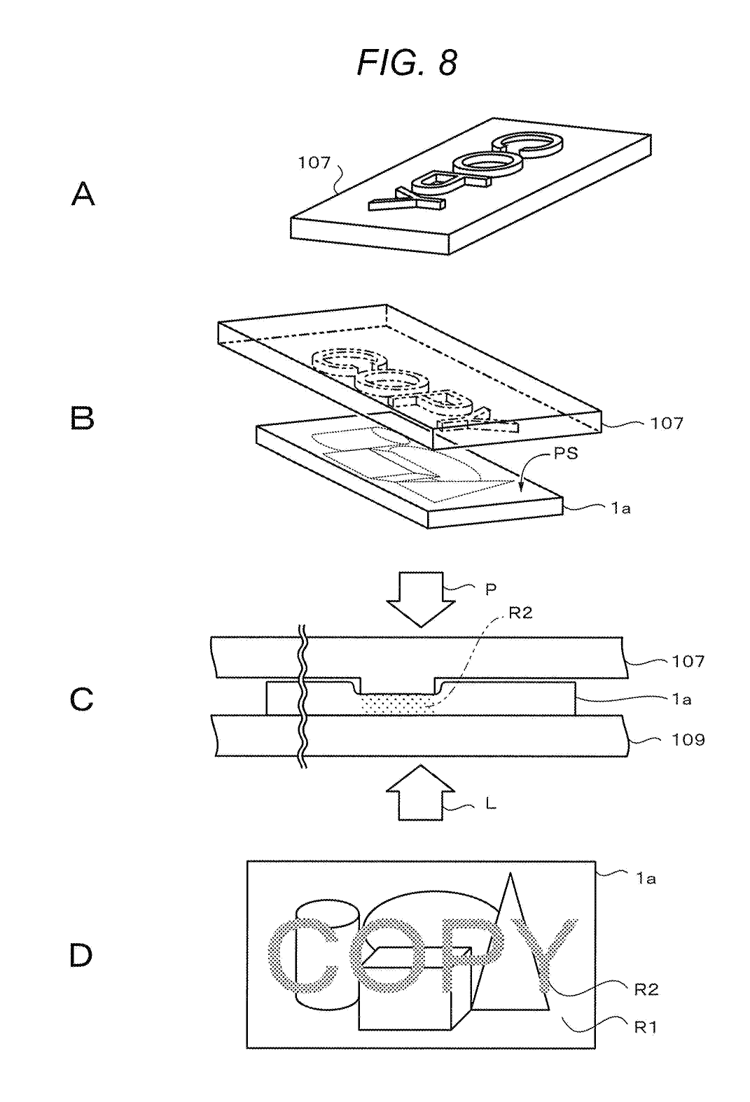

In order to press at least a portion of the laminated body 1a, for example, a press die in which a protruding portion is formed in some part thereof may be used. As illustrated in FIG. 8A, for example, a press die 107 formed with a character-like protruding portion “COPY” is used, so that the hologram recording layer 5 can be selectively pressed in the character-like region “COPY”. In this case, the shape of the protruding portion formed in the press die corresponds to the shape of the region R2 of the volume hologram 1. The shape of the protruding portion formed in the press die is set in any shape, and is not limited to the character shape “COPY”. Examples of materials constituting the press die 107 include glass, quartz, metal, resin material, and the like, but are not limited thereto. The press die 107 may not be formed in a flat plate shape. For example, it may be in a roll-shaped press die.

The laminated body 1a is arranged on a support body 109 that is not warped, and thereafter, as illustrated in FIG. 8B, a surface of the press die 107 formed with the protruding portion is arranged to face the exposure surface PS of the hologram recording layer 5. Like the materials constituting the press die 107, examples of materials constituting the support body 109 include glass, quartz, metal, resin material, and the like, but are not limited thereto. When the support body 109 is transparent, the light of the predetermined power may be emitted to the laminated body 1a via the support body 109.

Subsequently, as illustrated in FIG. 8C, by applying pressing force P onto the press die 107, the laminated body 1a placed on the support body 109 is pressed via the press die 107. At this occasion, the press die 107 is formed with the protruding portion, and therefore, required pressing force is applied onto only a portion of the hologram recording layer 5 corresponding to the shape of the protruding portion formed in the press die 107. When at least a portion of the laminated body 1a is pressed when the light of the predetermined power is emitted, for example, the light of the predetermined power is emitted onto the laminated body 1a via the support body 109 while at least a portion of the laminated body 1a is pressed. For example, with the emission L of the ultraviolet ray of the predetermined power by an ultraviolet ray lamp and the like, a recording image is fixed in the hologram recording layer 5. The light of the predetermined power to the laminated body 1a may be done by making the press die 107 using a transparent material and emitting light via the press die 107.

In order to emit the light of the predetermined power while pressing the laminated body 1a, for example, at least one of the press die 107 and the support body 109 is made to be transparent, and both of the press die 107 and the support body 109 may be configured to have a size larger than the laminated body 1a. For example, clamping pressure is applied to the press die 107 and the support body 109 so as to sandwich the external edge portions of the press die 107 and the support body 109 which are larger than the laminated body 1a. By doing so, the clamping pressure is applied to the press die 107 and the support body 109, and accordingly, only a portion of the laminated body 1a that is in contact with the protruding portion formed in the press die 107 can be selectively pressed. In addition, the light of the predetermined power can be emitted via at least one of the press die 107 and the support body 109, and therefore, the pressing of the laminated body 1a and the emission of the light of the predetermined power can be done at the same time. FIG. 8D schematically illustrates a top view of the laminated body 1a after the pressing and the emission of the light of the predetermined power. In

FIGS. 8C and 8D, the region R2 is shown as a shaded region.

When at least a portion of the laminated body 1a is pressed before the light of the predetermined power is emitted, the laminated body 1a may be pressed via the press die 107 and thereafter, the light of the predetermined power may be emitted. When at least a portion of the laminated body 1a is pressed after the light of the predetermined power is emitted, the light of the predetermined power may be emitted to the laminated body 1a, and thereafter, the laminated body 1a may be pressed via the press die 107. In any of the cases where at least a portion of the laminated body 1a is pressed before or after the light of the predetermined power is emitted, both of the press die 107 and the support body 109 or any one of them need to not be transparent.

It should be noted that, according to the present technique, the change of property of the hologram recording layer 5 can be controlled by changing the ratio between the protruding portion formed in the press die 107 and the portion other than the protruding portion (depressed portion) or changing the height and the width of the protruding portion (the depth and the width of the depressed portion).

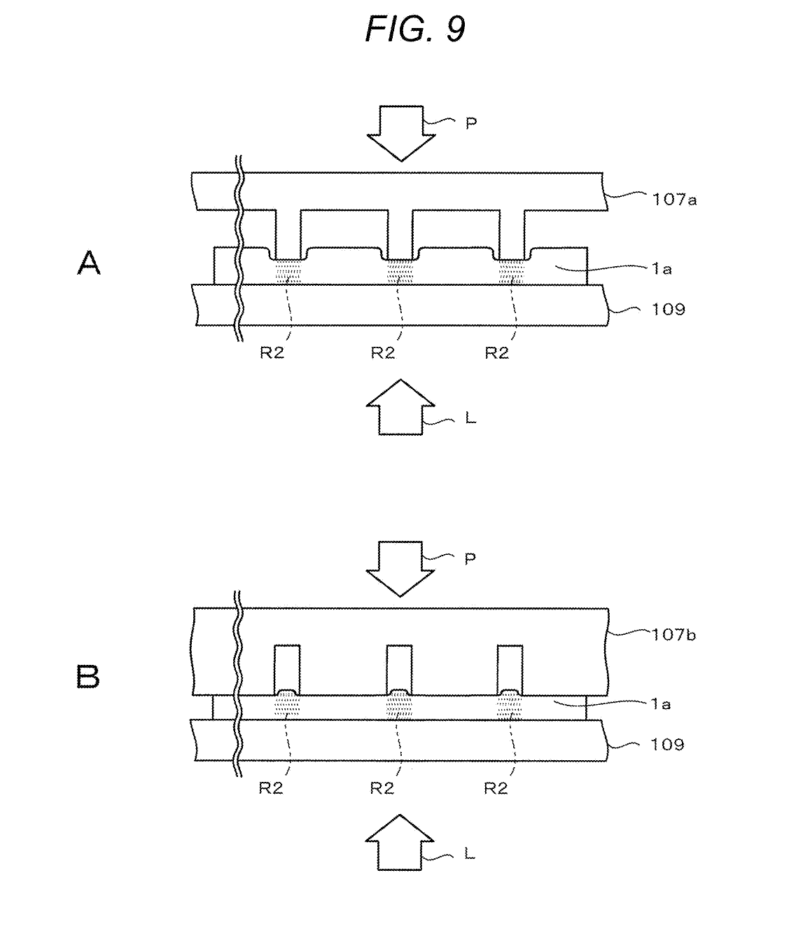

For example, as illustrated in FIG. 9A, when a press die 107a is used in which the ratio occupied by the protruding portion is configured to be smaller than the size of area of the exposure surface PS of the hologram recording layer 5, change of property occurs in the portion of the hologram recording layer 5 pressed by the protruding portion, like the case shown in FIG. 8C. On the other hand, as illustrated in FIG. 9B, when a press die 107b is used in which the ratio occupied by the protruding portion is configured to be larger than the size of area of the exposure surface PS of the hologram recording layer 5, the portion of the laminated body 1a that is not in contact with the protruding portion of the press die 107b enters into the depressed portion of the press die 107b. More specifically, the portion of the laminated body 1a that is not pressed by the protruding portion of the press die 107b enters into the depressed portion of the press die 107b. In this case, the portion of the laminated body 1a that enters into the depressed portion of the press die 107b is actively formed, so that change of property can be caused in the portion of the hologram recording layer 5 that is not pressed.

Required pressing force is applied to the portion of the hologram recording layer 5 corresponding to the shape of the protruding portion formed in the press die 107. In the portion of the pressing of the hologram recording layer 5 that is pressed or not pressed, for example, a change occurs, i.e., reduction of the degree of clearness of the interference pattern recorded onto a target of copy when contact copy is performed. More specifically, in the hologram recording layer 5, the pressed portion or the not-pressed portion becomes the region corresponding to the region R2 of the volume hologram 1. For this reason, the following changes occur in the pressed portion or the not-pressed portion: change of reduction of the degree of clearness of the interference pattern recorded to a target of copy, change of the refractive index in the thickness direction, change of the interference pattern recorded in the hologram recording layer 5, change of the thickness, or change of the wavelength spectrum of the diffracted light when white light is emitted from a predetermined angle.

When the change occurs in the hologram recording layer 5, for example, when an observer sees the volume hologram 1, the color perceived in the region R2 becomes different from the color perceived in the region R1. For example, the extension of the wavelength spectrum of the diffracted light becomes wider (broader) when white light is emitted from a predetermined angle.

When the change of the hologram recording layer includes the change of the thickness, the absolute value of difference between the thickness in the pressed region and the thickness in the not-pressed region is preferably within a range that is more than 0 but 30% or less as compared with the thickness in the not-pressed region. When the thickness in the pressed region and the thickness in the not-pressed region are different, the degree of clearness of the interference pattern recorded to the target of copy in the pressed portion or the not-pressed portion is reduced when contact copy is performed. This is because when the absolute value of the change of the thickness is 30% or less, the degree of clearness of the interference pattern recorded to the target of copy is reduced when contact copy is performed, and this can suppress deterioration of the reproduced image reproduced from the hologram due to excessive increase of the change of the pressed portion. The reason why the degree of clearness of the interference pattern recorded to the target of copy is reduced when contact copy is performed is considered to be because, when the change of the hologram recording layer includes change of the thickness due to the pressing, the interference pattern recorded in the hologram recording layer is changed.

In the volume hologram, the interval of interference fringes and the wavelength of the peak of the diffraction efficiency of the hologram (the reproduction wavelength of the hologram) are in inverse proportional relationship. For example, when the reproduction wavelength of the hologram changes from a reproduction wavelength around 532 nm (Y: 29.53, x: 0.177 y: 0.718 on Yxy chromaticity diagram) to a reproduction wavelength around 492 nm (Y: 30.21, x: 0.07 y: 0.35 on Yxy chromaticity diagram), then the color difference ΔE*_{ab} is about 80.11. At this occasion, in the simulation, the change of the thickness is about −7.5%. For example, when the reproduction wavelength of the hologram changes from a reproduction wavelength around 532 nm (Y: 29.53, x: 0.177 y: 0.718 on Yxy chromaticity diagram) to a reproduction wavelength around 562 nm (Y: 30.21, x: 0.36 y: 0.56 on Yxy chromaticity diagram), then the color difference ΔE*_{ab} is about 79.64, and at this occasion, the change of the thickness is about +5.4%.

When the change of the hologram recording layer includes the change of the thickness, the absolute value of difference between the thickness in the pressed region and the thickness in the not-pressed region is preferably within a range of more than 0 but 15% or less as compared with the thickness in the not-pressed region, and more preferably, within a range of more than zero but 8% or less. This is because this configuration can achieve not only the shift of the reproduction wavelength due to the application of the pressing force to the hologram recording layer but also suppression of the degradation of the reproduced image reproduced from the hologram.

(Post Processing Step)

Subsequently, as necessary, other functional layers are formed and other functional materials are attached to the laminated body 1a. For example, by applying and curing an ultraviolet ray cured resin, the protection layer 3 is formed at the exposure surface PS of the hologram recording layer 5. For example, the laminated body 1a is adhered to a laminated body having an adhesive layer 11 formed on a principal surface of a separator 13 made of resin such as polyethylene terephthalate.

As a result of the above steps, the volume hologram 1 according to an embodiment can be obtained. As necessary, the volume hologram 1 is die-cut or cut out, and the volume hologram 1 is subjected to inspection step, accumulation step, and the like.

### EXAMPLE

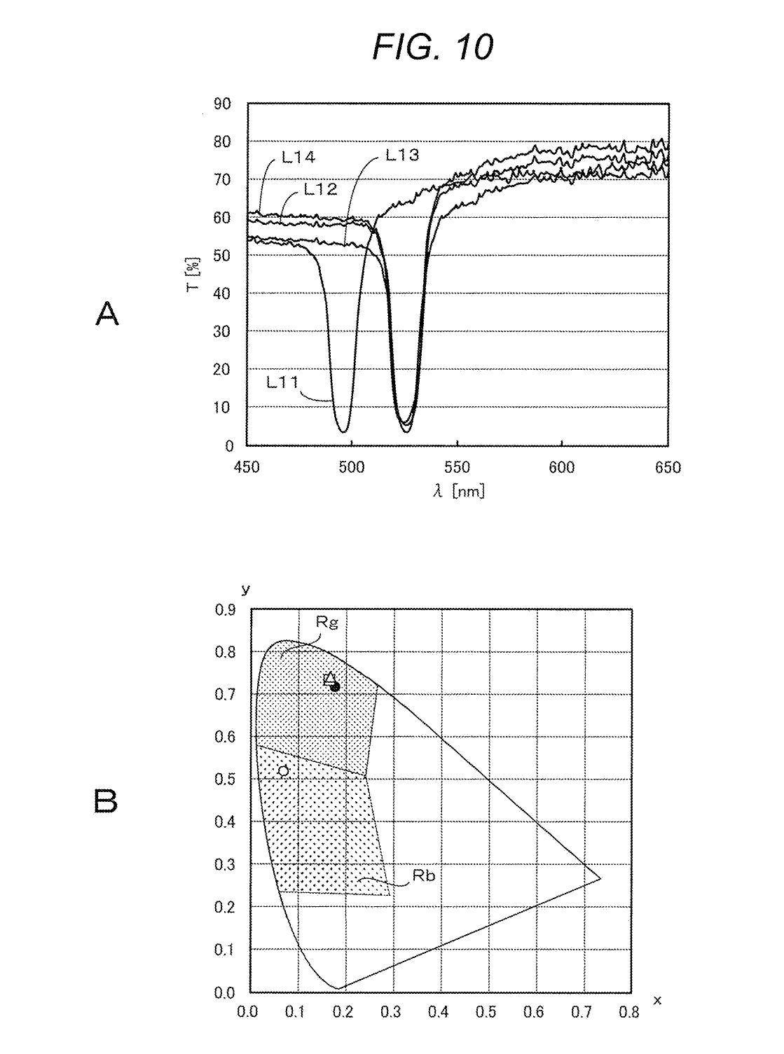

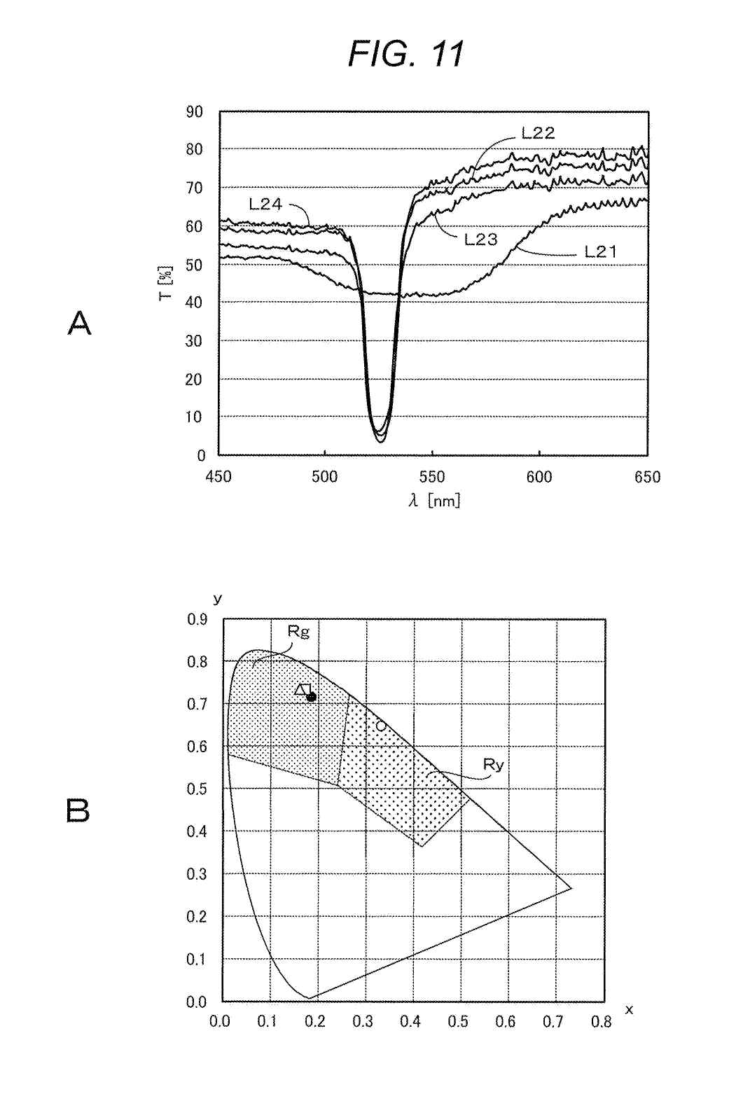

Hereinafter, the present technique will be explained more specifically using examples with reference to FIGS. 10A, 10B, 11A, and 11B, but the present technique is not limited to only these example.

### Example 1

### Evaluation by Measurement of Spectrum Characteristics

First, through measurement of spectrum characteristics, the change of the wavelength spectrum of the diffracted light due to pressing of the hologram recording layer recorded with the hologram was studied.

(Sample 1-1)

First, a resin sheet made of polyethylene terephthalate having a thickness 36 μm was prepared as a base material layer.

Subsequently, using die coating method, a hologram recording layer having a thickness 15 μm made of light-cured photopolymer (which may be hereinafter referred to as photopolymer PP1 as necessary) was formed on a principal surface of the resin sheet of polyethylene terephthalate.

Subsequently, a white plate of which entire surface is white and the hologram master plate were exposed with laser light of a wavelength 532 nm, and the hologram was recorded in the hologram master plate. Subsequently, using contact copy, the hologram of the hologram master plate was copied to the hologram recording layer. In the contact copy, laser light of a wavelength 532 nm was used.

Subsequently, after a laminated body including a base material layer and a hologram recording layer was cut into a size of 10 mm square, it was sandwiched between two glass base materials, and clamping pressure was applied to the two glass base materials, and pressing force was applied to the hologram recording layer. Among the two glass base materials, a glass base material formed with multiple protruding portions was used for the glass base material at the hologram recording layer, so that the hologram recording layer and the protruding portion face each other. Like the press die 107a as illustrated in FIG. 9A, the glass base material at the hologram recording layer used a material in which the ratio occupied by the multiple protruding portions with respect to the size of area of the hologram recording layer is smaller as compared with the portion other than the protruding portions (depressed portion). More specifically, the ratio between the multiple protruding portions occupied with respect to the size of area of the hologram recording layer and the portion other than the protruding portions (depressed portion) was set as 1:2 in the glass base material at the hologram recording layer. At this occasion, when the clamping pressure was applied to the two glass base materials, an ultraviolet ray lamp was used to emit an ultraviolet ray to the hologram recording layer via the glass base material which is in contact with the hologram recording layer, at the same time. Hereinafter, a condition of ultraviolet ray emission and pressing force to the laminated body of the hologram recording layer and the base material layer will be shown.

Pressing force: 500 kgf/cm² (49 MPa)

Emission energy of ultraviolet ray: 7 mW/cm²×30 min

According to the above procedure, the volume hologram of the sample 1-1 was obtained.

(Sample 1-2)

A volume hologram of the sample 1-2 was obtained in the same manner as the sample 1-1 except that a laminated body of a base material layer and a hologram recording layer was sandwiched between two glass base materials, and the clamping pressure was applied to the two glass base materials, and after the clamping pressure was released, an ultraviolet ray was emitted.

(Sample 1-3)

A volume hologram of the sample 1-3 was obtained in the same manner as the sample 1-1 except that a laminated body of a base material layer and a hologram recording layer was sandwiched between two glass base materials, and after an ultraviolet ray was emitted, clamping pressure was applied to the two glass base materials.

(Sample 1-4)

A volume hologram of the sample 1-4 was obtained in the same manner as the sample 1-1 except that an ultraviolet ray was emitted without applying the clamping pressure to the two glass base materials.

[Spectrum Characteristics]

For each of sample 1-1 to sample 1-4, spectrum characteristics in regions including portions which are in contact with the protruding portions of the glass base materials were measured according to the measurement method as illustrated in FIG. 2A. FIG. 10A illustrates measurement results of spectrum characteristics of sample 1-1 to sample 1-4.

FIG. 10A is a graph in which the horizontal axis denotes a wavelength λ [nm] of transmitted light, and the vertical axis denotes a transmittance T [%]. In FIG. 10A, L11, L12, L13 and L14 correspond to measurement results of spectrum characteristics of sample 1-1 to sample 1-4, respectively. When the volume hologram of sample 1-1 and the volume holograms of sample 1-2 to 1-4 are compared in FIG. 10A, it is understood that the volume hologram of sample 1-1 is such that the wavelength of the peak of the diffraction efficiency is shifted to a shorter wavelength side. Hereinafter, for each sample, the wavelength of the peak of the diffraction efficiency obtained from the measurement of the spectrum characteristics will be shown.

Sample 1-1: 492.6 nm

Sample 1-2: 523.9 nm

Sample 1-3: 526.7 nm

Sample 1-4: 527.5 nm

FIG. 10B is a figure illustrating points corresponding to peaks diffraction efficiency of sample 1-1 to sample 1-4 which are shown on a chromaticity diagram of Yxy color system defined by CIE. In FIG. 10B, point “◯” denotes a chromaticity coordinate of a point corresponding to the peak of the diffraction efficiency of sample 1-1. Likewise, a point “□”, a point “Δ”, and a point “” denotes chromaticity coordinates of points corresponding to the peak of the diffraction efficiency of sample 1-2, sample 1-3, and sample 1-4, respectively.

In FIG. 10B, a region Rg indicated by dark shade is a region in which perceived color is substantially green, and a region Rb indicated by light shade is a region in which perceived color is substantially blue. Therefore, when the volume hologram of sample 1-1 is observed, the volume hologram of sample 1-1 appears to be green-like color.

With regard to the wavelength of the peak of the diffraction efficiency of sample 1-1 to sample 1-4, (Y, x, y) in Yxy color system and (L*, a*, b′) in L*a*b* color system are shown below in Table 1.

TABLE 1

| | xyY color | | | L*a*b* color | | |
|---|---|---|---|---|---|---|
| | system | | | system | | |
| | Y | x | y | L* | a* | b* |
| Sample 1-1 | 30.21 | 0.07 | 0.52 | 61.83 | −160.61 | 13.69 |
| Sample 1-2 | 34.62 | 0.165 | 0.734 | 65.45 | −134.0 | 69.96 |
| Sample 1-3 | 33.51 | 0.168 | 0.742 | 64.57 | −132.0 | 72.07 |
| Sample 1-4 | 29.53 | 0.177 | 0.718 | 61.25 | −120.6 | 64.98 |

Hereinafter, color difference ΔE*_{ab} between sample 1-4 and sample 1-1 to sample 1-3 obtained from (L*, a*, b*) shown in Table 1 will be shown.

Between sample 1-1 and sample 1-4: ΔE*_{ab}=65.04

Between sample 1-2 and sample 1-4: ΔE*_{ab}=14.85

Between sample 1-3 and sample 1-4: ΔE*_{ab}=13.81

The following facts were found from FIG. 10A, FIG. 10B, and Table 1.

As can be seen from the measurement results of sample 1-1 to sample 1-4, it was understood that the wavelength of the peak of the diffraction efficiency can be shifted by applying pressing force to the hologram recording layer. In sample 1-1, the wavelength of the peak of the diffraction efficiency is shifted to a shorter wavelength side by 30 nm, and when the emission of the light of the predetermined power and the pressing are performed at the same time, this enhances the effect of shifting the wavelength of the peak of the diffraction efficiency.

Subsequently, with the glass base material at the hologram recording layer side, the ratio between the multiple protruding portions occupied with respect to the size of area of the hologram recording layer and the portion other than the protruding portions (depressed portion) was changed, and the same evaluation was performed.

(Sample 2-1)

First, a resin sheet made of polyethylene terephthalate having a thickness 36 μm was prepared as a base material layer.

Subsequently, using die coating method, a hologram recording layer having a thickness 15 μm made of light-cured photopolymer which is different from the photopolymer PP1 was formed on a principal surface of the resin sheet of polyethylene terephthalate.

Subsequently, a white plate of which entire surface is white and the hologram master plate were exposed with laser light of a wavelength 532 nm, and the hologram was recorded in the hologram master plate. Subsequently, using contact copy, the hologram of the hologram master plate was copied to the hologram recording layer. In the contact copy, laser light of a wavelength 532 nm was used.

Subsequently, after a laminated body including a base material layer and a hologram recording layer was cut into a size of 10 mm square, it was sandwiched between two glass base materials, and clamping pressure was applied to the two glass base materials, and pressing force was applied to the hologram recording layer. Among the two glass base materials, a glass base material formed with multiple protruding portions was used for the glass base material at the hologram recording layer, so that the hologram recording layer and the protruding portion face each other. Like the press die 107b as illustrated in FIG. 9B, the glass base material at the hologram recording layer used a material in which the ratio occupied by the multiple protruding portions with respect to the size of area of the hologram recording layer is larger as compared with the portion other than the protruding portions (depressed portion). More specifically, the ratio between the multiple protruding portions occupied with respect to the size of area of the hologram recording layer and the portion other than the protruding portions (depressed portion) was set as 2:1 in the glass base material at the hologram recording layer. At this occasion, when the clamping pressure was applied to the two glass base materials, an ultraviolet ray lamp was used to emit an ultraviolet ray to the hologram recording layer via the glass base material which is in contact with the hologram recording layer, at the same time. Hereinafter, a condition of ultraviolet ray emission and pressing force to the laminated body of the hologram recording layer and the base material layer will be shown.

Pressing force: 500 kgf/cm² (49 MPa)

Emission energy of ultraviolet ray: 7 mW/cm²×30 min

According to the above procedure, the volume hologram of the sample 2-1 was obtained.

(Sample 2-2)

A volume hologram of the sample 2-2 was obtained in the same manner as the sample 2-1 except that a laminated body of a base material layer and a hologram recording layer was sandwiched between two glass base materials, and the clamping pressure was applied to the two glass base materials, and after the clamping pressure was released, an ultraviolet ray was emitted.

(Sample 2-3)

A volume hologram of the sample 2-3 was obtained in the same manner as the sample 2-1 except that a laminated body of a base material layer and a hologram recording layer was sandwiched between two glass base materials, and after an ultraviolet ray was emitted, clamping pressure was applied to the two glass base materials.

(Sample 2-4)

A volume hologram of the sample 2-4 was obtained in the same manner as the sample 2-1 except that an ultraviolet ray was emitted without applying the clamping pressure to the two glass base materials.

[Spectrum Characteristics]

For each of sample 2-1 to sample 2-4, spectrum characteristics in regions including portions which are not in contact with the protruding portions of the glass base materials were measured according to the measurement method as illustrated in FIG. 2A. FIG. 11A illustrates measurement results of spectrum characteristics of sample 2-1 to sample 2-4.

FIG. 11A is a graph in which the horizontal axis denotes a wavelength λ [nm] of transmitted light, and the vertical axis denotes a transmittance T [%]. In FIG. 11A, L21, L22, L23 and L24 correspond to measurement results of spectrum characteristics of sample 2-1 to sample 2-4, respectively. When the volume hologram of sample 2-1 and the volume holograms of sample 2-2 to 2-4 are compared in FIG. 11A, it is understood that the volume hologram of sample 2-1 is such that the wavelength of the peak of the diffraction efficiency is shifted to a longer wavelength side. Hereinafter, for each sample, the wavelength of the peak of the diffraction efficiency obtained from the measurement of the spectrum characteristics will be shown.

Sample 2-1: 536.2 nm

Sample 2-2: 524.9 nm

Sample 2-3: 525.7 nm

Sample 2-4: 525.7 nm

FIG. 11B is a figure illustrating points corresponding to peaks diffraction efficiency of sample 2-1 to sample 2-4 which are shown on a chromaticity diagram of Yxy color system defined by CIE. In FIG. 11B, point “◯” denotes a chromaticity coordinate of a point corresponding to the peak of the diffraction efficiency of sample 2-1. Likewise, a point “□”, a point “Δ”, and a point “” denotes chromaticity coordinates of points corresponding to the peak of the diffraction efficiency of sample 2-2, sample 2-3, and sample 2-4, respectively.

In FIG. 11B, a region Rg indicated by dark shade is a region in which perceived color is substantially green, and a region Ry indicated by light shade is a region in which perceived color is substantially yellow. Therefore, when the volume hologram of sample 2-1 is observed, the volume hologram of sample 2-1 appears to be yellow-like color.

With regard to the wavelength of the peak of the diffraction efficiency of sample 2-1 to sample 2-4, (Y, x, y) in Yxy color system and (L*, a*, b*) in L*a*b* color system are shown below in Table 2.

TABLE 2

| | xyY color | | | L*a*b* color | | |
|---|---|---|---|---|---|---|
| | system | | | system | | |
| | Y | x | y | L* | a* | b* |
| Sample 2-1 | 62.73 | 0.33 | 0.65 | 83.3 | −80.73 | 119.06 |
| Sample 2-2 | 34.56 | 0.17 | 0.73 | 65.4 | −131.3 | 70.02 |
| Sample 2-3 | 33.76 | 0.16 | 0.74 | 64.77 | −131.3 | 72.19 |
| Sample 2-4 | 29.46 | 0.18 | 0.72 | 61.19 | −119.5 | 66.09 |

Hereinafter, color difference ΔE*_{ab} between sample 2-4 and sample 2-1 to sample 2-3 obtained from (L*, a*, b*) shown in Table 2 will be shown.

Between sample 2-1 and sample 2-4: ΔE*_{ab}=69.28

Between sample 2-2 and sample 2-4: ΔE*_{ab}=13.11

Between sample 2-3 and sample 2-4: ΔE*_{ab}=13.71

The following facts were found from FIG. 11A, FIG. 11B, and Table 2.

As can be seen from the measurement results of sample 2-1 to sample 2-4, it was understood that the wavelength spectrum of the diffracted light when white light is emitted from a predetermined angle can be made broader by applying pressing force to the hologram recording layer. In sample 2-1, the wavelength of the peak of the diffraction efficiency is shifted to a longer wavelength side by 10 nm, and it is understood that, when the emission of the light of the predetermined power and the pressing are performed at the same time, the wavelength of the peak of the diffraction efficiency can be shifted.

When FIGS. 10A and 10B and Table 1 and FIGS. 11A and 11B and Table 2 are compared, the following facts were found.

In the glass base material at the hologram recording layer, it was found that the wavelength of the peak of the diffraction efficiency can also be shifted to a shorter wavelength side by changing the ratio between the multiple protruding portions occupied with respect to the size of area of the hologram recording layer and the portion other than the protruding portions (depressed portion). The reason why the amount of shift of sample 2-1 is smaller than the amount of shift of sample 1-1 is considered to be that, as compared with direct pressing with the protruding portion into the hologram recording layer, the amount of deformation of the hologram recording layer is smaller in the case of deformation for making the hologram recording layer pressed into the depressed portion. In other words, it can be said that, even with the same pressing force, the amount of shift of the wavelength of the peak of the diffraction efficiency can be controlled by changing the ratio of the protruding portion and the depressed portion occupied with respect to the size of area of the hologram recording layer.

As described above, the wavelength spectrum of the diffracted light can be shifted by performing pressing operation onto the hologram recording layer recorded with the hologram. Therefore, according to the present technique, in the volume hologram, the wavelength of the peak of the diffraction efficiency can also be shifted after the hologram is reproduced. Further, the wavelength of the peak of the diffraction efficiency can be shifted selectively in some region of the volume hologram by setting the pressed region as necessary.

### Example 2

### Evaluation Based on Simulation

Subsequently, relationship between change of the thickness of the volume hologram and the reproduction wavelength of the hologram will be studied based on simulation.

(Sample 3-1)

First, a resin sheet made of polyethylene terephthalate having a thickness 36 μm was prepared as a base material layer. Each physical property value of polyethylene terephthalate used for making resin sheet will be shown below.

Transmittance: 88%

Haze: 2 to 3%

Refractive index: 1.66

Retardation: 700 to 1500 nm

Subsequently, using die coating method, a hologram recording layer made of the photopolymer PP1 was formed on a principal surface of the resin sheet of polyethylene terephthalate.

Subsequently, a white plate of which entire surface is white and the hologram master plate were exposed with laser light of a wavelength 532 nm, and the hologram was recorded in the hologram master plate. Subsequently, using contact copy, the hologram of the hologram master plate was copied to the hologram recording layer. In the contact copy, laser light of a wavelength 532 nm was used.

Subsequently, after a laminated body including a base material layer and a hologram recording layer was cut into a size of 10 mm square, it was sandwiched between two glass base materials, and clamping pressure was applied to the two glass base materials, and pressing force was applied to the hologram recording layer. Among the two glass base materials, a glass base material formed with multiple protruding portions was used for the glass base material at the hologram recording layer, so that the hologram recording layer and the protruding portion face each other. Like the press die 107a as illustrated in FIG. 9A, the glass base material at the hologram recording layer used a material in which the ratio occupied by the multiple protruding portions with respect to the size of area of the hologram recording layer is smaller as compared with the portion other than the protruding portions (depressed portion). More specifically, the ratio between the multiple protruding portions occupied with respect to the size of area of the hologram recording layer and the portion other than the protruding portions (depressed portion) was set as 1:2 in the glass base material at the hologram recording layer. At this occasion, when the clamping pressure was applied to the two glass base materials, an ultraviolet ray lamp was used to emit an ultraviolet ray to the hologram recording layer via the glass base material which is in contact with the hologram recording layer, at the same time. Hereinafter, a condition of ultraviolet ray emission and pressing force to the laminated body of the hologram recording layer and the base material layer will be shown.

Pressing force: 500 kgf/cm² (49 MPa)

Emission energy of ultraviolet ray: 7 mW/cm²×30 min

According to the above procedure, the volume hologram of the sample 3-1 was obtained.

When a pressed region of the volume hologram of sample 3-1 made by a protruding portion of a glass base material is observed under a white light source, the color of the reproduced image in the region was blue.

(Sample 3-2)

Subsequently, the volume hologram of sample 3-2 was obtained in the same manner as sample 3-1 except change of the shape of the surface of the glass base material for applying pressing force to the hologram recording layer. Like the press die 107b as illustrated in FIG. 9B, in the pressing of the hologram recording layer, the glass base material at the hologram recording layer used a material in which the ratio occupied by the multiple protruding portions with respect to the size of area of the hologram recording layer is larger as compared with the portion other than the protruding portions (depressed portion). More specifically, the ratio between the multiple protruding portions occupied with respect to the size of area of the hologram recording layer and the portion other than the protruding portions (depressed portion) was set as 2:1 in the glass base material at the hologram recording layer.

When a not-pressed region of the volume hologram of sample 3-2 that is not pressed by a protruding portion of a glass base material is observed under a white light source, the color of the reproduced image in the region was red.

(Sample 3-3)

A volume hologram of the sample 3-3 was obtained in the same manner as the sample 3-1 except that an ultraviolet ray was emitted without applying the clamping pressure to the two glass base materials. Hereinafter, the refractive index of the photopolymer PP1 before and after curing will be shown.

Refractive index (before curing): 1.492

Refractive index (after curing): 1.485

When the volume hologram of sample 3-3 is observed under white light, the color of the reproduced image was green.

In this case, change of the thickness of the hologram recording layer due to pressing was studied by measuring the surface shape of each sample. Hereinafter, the measurement machine and data analysis software used in this measurement will be shown.

Extremely high accuracy non-contact three-dimensional surface property measurement machine . . . Talysurf CCI6000 by Taylor Hobson Ltd

Data analysis software . . . TalyMap Platinum by Taylor Hobson Ltd

Further, the reproduction wavelength of the hologram expected from the amount of change of the thickness of the hologram recording layer concerning each sample is derived from calculation, and the measurement result of the surface shape and the reproduction wavelength of the hologram are compared.

Hereinafter, overview of calculation of the reproduction wavelength of the hologram will be explained.

First, suppose a flat plate shaped hologram recording layer one side of which has a length L and thickness of which is t, and in xyz orthogonal coordinate, the direction parallel to the side having the length L and the thickness direction are adopted in the x axis direction and the z axis direction, respectively.

First, relationship is derived between an interval λ_{V} of interference fringes formed by light incident upon the hologram recording layer and a wavelength λ of incident light. In the explanation below, the light source and the observer's viewpoint are deemed to be sufficiently away from the surface of the hologram recording layer, and the any one of the lights is deemed to be a plane wave, and in this condition, calculation is performed.

Where the incident angle of the object light and the reference light incident upon the hologram recording layer from air (of which refractive index is one) are denoted as θ_{S}, θ_{R}, respectively, an amplitude distribution Σ_{S} of the object light and an amplitude distribution Σ_{R} of the reference light within zx plane are represented in the following expressions (3) and (4) shown below. In this case, in the expressions, i denotes imaginary unit, and k denotes wave number (k=2π/λ).

[Math 2]

Σ_{S}=exp[ik(x sin θ_{S}+z cos θ_{S})] (3)

[Math 3]

Σ_{R}=exp[ik(x sin θ_{R}+z cos θ_{R})] (4)

Therefore, the intensity distribution of amplitude caused by interference of the object light and the reference light is derived from the expression (5) below.

$$\begin{matrix}[ Math 4 ] & \\ \begin{matrix}{\vert {\sum }_{S} + {\sum }_{R} \vert}^{2} = ( {\sum }_{S} + {\sum }_{R} ) * ( {\sum }_{S} + {\sum }_{R} ) \\ = 2 \{ 1 + cos [ \frac{2 π}{λ} \{ \begin{matrix}x ( sin {θ}_{S} - sin {θ}_{R} ) + \\ z ( cos {θ}_{S} - cos {θ}_{R} )\end{matrix} \} ] \}\end{matrix} & ( 5 )\end{matrix}$$

Therefore, concerning the traveling direction of the composite wave of the object light and the reference light, the interval of points where intensity of the amplitude is the maximum is derived from the expression (6) below, where N is an integer.

$$\begin{matrix}[ Math 5 ] & \\ cos [ \frac{2 π}{λ} \{ x ( sin {θ}_{S} - sin {θ}_{R} ) + z ( cos {θ}_{S} - cos {θ}_{R} ) \} ] = cos 2 π N & ( 6 )\end{matrix}$$

Where θ_{F}=(θ_{S}+θ_{R})/2 is set, and the expression (6) is organized. Then, the following expression (7) below can be obtained.

$$\begin{matrix}[ Math 6 ] & \\ x cos {θ}_{F} - z sin {θ}_{F} = \frac{N λ}{2 sin ( \frac{{θ}_{S} - {θ}_{R}}{2} )} & ( 7 )\end{matrix}$$

As can be understood from the expression (7), the interference fringes are formed in parallel with the direction forming the angle θ_{F} with respect to the z axis. Where j is an integer, a difference is derived between the expression (7) where N=(j+1) and the expression (7) where N=j, and as can be understood from this, the interval λ of the interference fringes is expressed by the following expression (8) below.

$$\begin{matrix}[ Math 7 ] & \\ Λ = \frac{λ}{\vert 2 sin ( \frac{{θ}_{S} - {θ}_{R}}{2} ) \vert} & ( 8 )\end{matrix}$$

Therefore, it is understood that, when the refractive index of the hologram recording layer is denoted as n, consequently, the interval λ_{V} of the interference fringes formed by the light incident upon the hologram recording layer is expressed by the following expression (9) below. In the expression (9), θ_{S} denotes the incident angle of the object light in the hologram recording layer, and θ_{R} is the incident angle of the reference light in the hologram recording layer.

$$\begin{matrix}[ Math 8 ] & \\ {Λ}_{V} = \frac{λ / n}{2 \vert sin ( \frac{{θ}_{S} - {θ}_{R}}{2} ) \vert} & ( 9 )\end{matrix}$$

Subsequently, relationship between output direction of the reproduction light (diffracted light) from the hologram recording layer and the wavelength of the reproduction light will be considered. For this reason, first, a condition for reproducing a recorded image from a hologram recording layer with respect to reproduction light is derived.

In order to avoid complexity in calculation, the refractive index of the hologram recording layer n is considered to be 1. In this case, a component T_{A} reproducing direct light in the amplitude transmittance distribution of the hologram recording layer is expressed by the following expression (10).

[Math 9]

T_{A}=exp[ik{x(sin θ_{S}−sin θ_{R})+z(cos θ_{S}−cos θ_{R})}] (10)

If, as illumination light, parallel light Σ_{C} expressed by the following expression (11) is incident upon the hologram recording layer, the complex amplitude distribution Σ_{C}′ of light which is output in the direction of θ_{C} is expressed in the form of following expression (12). In the expression, k_{C} denotes a wave number concerning the parallel light Σ_{C}.

$$\begin{matrix}[ Math 10 ] & \\ {\sum }_{C} = exp [ i {k}_{C} ( x sin {θ}_{C} + z cos {θ}_{C} ) ] & ( 11 ) \\ [ Math 11 ] & \\ \begin{matrix}{\sum }_{C}^{′} = {\int }_{- L / 2}^{+ L / 2} {\int }_{0}^{t} {T}_{A} exp [ i {k}_{C} \{ \begin{matrix}x ( sin {θ}_{C} - sin {θ}_{C}^{′} ) + \\ z ( cos {θ}_{C} - cos {θ}_{C}^{′} )\end{matrix} \} ] d z d x \\ = \frac{sin α}{α} \frac{sin β}{β}\end{matrix} & ( 12 )\end{matrix}$$

In this case, α and β in the expression (12) are expressed by the following expressions (13) and (14), respectively.

$$\begin{matrix}[ Math 12 ] & \\ α = \frac{L}{2} \{ k ( sin {θ}_{S} - sin {θ}_{R} ) + {k}_{C } ( sin {θ}_{C} - sin {θ}_{C}^{′} ) \} & ( 13 ) \\ [ Math 13 ] & \\ β = \frac{t}{2} \{ k ( cos {θ}_{S} - cos {θ}_{R} ) + {k}_{C } ( cos {θ}_{C} - cos {θ}_{C}^{′} ) \} & ( 14 )\end{matrix}$$

In order to reproduce the recorded image from the hologram recording layer, the complex amplitude distribution Σ_{C} needs to be the maximum. More specifically, it is required to satisfy α=0 and β=0 where t≠0, and therefore, in order to reproduce the recorded image from the hologram recording layer as the virtual image, the following expressions need to be satisfied: λ_{C}=λ and θ_{C}=θ_{R} and θ_{C}′=θ_{S}. It should be noted that λ_{C} is the wavelength of the parallel light Σ_{C}.

Subsequently, relationship between the thickness of the hologram recording layer and the reproduction wavelength of the hologram will be considered.

In order to taken the refractive index of the hologram recording layer into consideration, the expression (14) concerning the thickness of the hologram recording layer and the reproduction wavelength of the hologram may be rewritten in the form of the expression (15) below. Further, when the interval λ_{V} of the interference fringes introduced in the expression (9) explained above is used, the following expression (16) is obtained. In the expression (15) and the expression (16), θ_{C} is the incident angle of the illumination light in the hologram recording layer, and θ_{C}′ is the output angle of the reproduction light in the hologram recording layer. In the expression (16), θ_{F}=(θ_{S}+θ_{R})/2 holds.

$$\begin{matrix}[ Math 14 ] & \\ β = \frac{t}{2} \{ \frac{2 π n}{λ} ( cos {Θ}_{S} - cos {Θ}_{R} ) + \frac{2 π n}{{λ}_{C}} ( cos {Θ}_{C} - cos {Θ}_{C}^{′} ) \} & ( 15 ) \\ [ Math 15 ] & \\ β = π t \{ \frac{1}{{Λ}_{V}} sin {Θ}_{F} + \frac{n}{{λ}_{C}} ( cos {Θ}_{C} - cos {Θ}_{C}^{′} ) \} & ( 16 )\end{matrix}$$

λ_{C}=λ and θ_{C}=θ_{R} and θ_{C}′=θ_{S} which are conditions for reproducing the virtual image from the hologram recording layer are rewritten with λ_{C}=λ and θ_{C}=θ_{R} and θ_{C}′=θ_{S}, and when this is applied to the expression (16) where β=0, t≠0 and sin θ_{F}≠0, the following expression (17) is obtained.

[Math 16]

λ=2nΛ_{V} sin Θ_{B} (17)

As described above, relationship between the output direction of the reproduction light from the hologram recording layer and the wavelength of the reproduction light is obtained as the expression (17). In the expression (17), θ_{B}=(θ_{S}−θ_{R})/2 is the size of the angle formed by the optical axis of the illumination light forms and the interference fringes.

In this case, when the thickness t of the hologram recording layer changes, the angle θ_{F} corresponding to the inclination of the interference fringes with respect to the z axis and the interval λ_{V} of the interference fringes are considered to change in accordance with the change of the thickness t. In accordance with the change of the angle θ_{F}, the size θ_{B} of the angle formed by the optical axis of the illumination light and the interference fringes are also considered to change.

The expression (17) indicates that, when the interval λ_{V} and the angle θ_{B} of the interference fringes change in accordance with the change of the thickness t of the hologram recording layer, the wavelength of the reproduction light changes. More specifically, when the pressed volume hologram after pressing is observed under the same illumination as that when the not-yet pressed volume hologram is observed, the color perceived in the pressed volume hologram becomes a color different from the color perceived in the not-yet pressed volume hologram.

The wavelength of the reproduction light after the change of the thickness t of the hologram recording layer can be calculated using the expression (17) by deriving the change of the angle θ_{B} and the change of the interval λ_{V} of the interference fringes due to the change of the thickness t of the hologram recording layer.

Table 3 below shows a measurement result of change of the thickness of the hologram recording layer due to the pressing and a simulation result of the reproduction wavelength of the hologram expected from the amount of change of the thickness of the hologram recording layer concerning each sample. The simulation result of the reproduction wavelength of the hologram as illustrated in Table 3 below is derived based on the expression (17) from the measurement result of change of the thickness of the hologram recording layer.

In Table 3, Ttotal denotes the measurement result of the total thickness of each sample. Tph denotes the thickness of each hologram recording layer of each sample, and Tph is Ttotal−(thickness of polyethylene terephthalate: 36 μm). Dif denotes a difference between an average value of Tph concerning each sample and an average value of Tph concerning sample 3-3 as a reference. On the other hand, λsim is the reproduction wavelength of the hologram derived from simulation based on the expression (17) from the value Dif concerning each sample. In the simulation of the reproduction wavelength of the hologram, the angles are set as follows: the incident angle θ_{S} of the object light is 180°, the incident angle θ_{R} of the reference light is 45°, and the incident angle θ_{C} of the reference light is 45°.

TABLE 3

| | Ttotal [μm] | | | Tph [μm] | | | Dif | λ sim |
|---|---|---|---|---|---|---|---|---|
| | min | ave | max | min | ave | max | [μm] | [μm] |
| Sample | 51.6 | 52.2 | 52.8 | 15.6 | 16.2 | 16.8 | −2.3 | 0.465 |
| 3-1 | | | | | | | | |
| Sample | 57.5 | 58.1 | 58.7 | 21.5 | 22.1 | 22.7 | 3.6 | 0.634 |
| 3-2 | | | | | | | | |
| Sample | 54.1 | 54.5 | 54.9 | 18.1 | 18.5 | 18.9 | 0 | 0.532 |
| 3-3 | | | | | | | | |

When the simulation result of the reproduction wavelength of the hologram is confirmed from Table 3, the following facts were found.

It is known that the light in the wavelength band of 450 to 495 [nm] is recognized as the light of blue color, and he light in the wavelength band of 620 to 750 [nm] is recognized as the light of red color. On the other hand, it is known that the light in the wavelength band of 495 to 570 [nm] is recognized as the light of green color. More specifically, according to the simulation result of the reproduction wavelength of the hologram, the colors of the reproduced images expected from the amount of change of the thickness of the hologram recording layer of sample 3-1 and sample 3-2 are blue and red, respectively.

As described above, the color of the reproduced image in the pressed region of the volume hologram of sample 3-1 and the color of the reproduced image in the not-pressed region of the volume hologram of sample 3-2 are blue and red, respectively. The color of the reproduced image of the volume hologram of sample 3-3 is green. Therefore, it is understood that correlation between change of the thickness of the hologram recording layer and the color of the reproduced image is also achieved.

As described above, it is found that the thickness of the hologram recording layer during the recording of the hologram is not changed but the thickness of the hologram recording layer after the recording of the hologram is changed, whereby the reproduction wavelength of the hologram is changed, and the wavelength spectrum of the diffracted light can be shifted. At this occasion, when the thickness of the hologram recording layer is reduced as compared with the thickness of the hologram recording layer during recording of the hologram, the reproduction wavelength of the hologram is shifted to the shorter wavelength side. When the thickness of the hologram recording layer is increased as compared with the thickness of the hologram recording layer during recording of the hologram, the reproduction wavelength of the hologram is shifted to the longer wavelength side.

More specifically, the wavelength spectrum of the diffracted light can be shifted by performing pressing operation onto the hologram recording layer recorded with the hologram. Therefore, according to the present technique, in the volume hologram, the wavelength of the peak of the diffraction efficiency can also be shifted after the hologram is reproduced. Further, the wavelength of the peak of the diffraction efficiency can be shifted selectively in some region of the volume hologram by setting the pressed region as necessary.

According to the present technique, after the hologram is recorded, the wavelength of the peak of the diffraction efficiency can be shifted. Therefore, when forming a region in which the wavelength of the peak of the diffraction efficiency is configured to be different, it is not necessary to use light sources of multiple wavelengths. In other words, according to the present technique, the thickness of the hologram recording layer after recording of the hologram is controlled, whereby quasi color histogram can be obtained even with one hologram recording step using a single light source. Moreover, in the present technique, unlike the method for recording a hologram upon swelling a hologram recording layer in advance, it is not necessary to derive, in advance, the swelling ratio in accordance with a desired reproduction wavelength, and therefore, the wavelength during recording of the histogram can be set with a high degree of flexibility.

According to the present technique, without complicating the manufacturing step of the volume hologram, the function of copy protection of the volume hologram can be improved.

### 2. Modification

[First Modification of Volume Hologram]

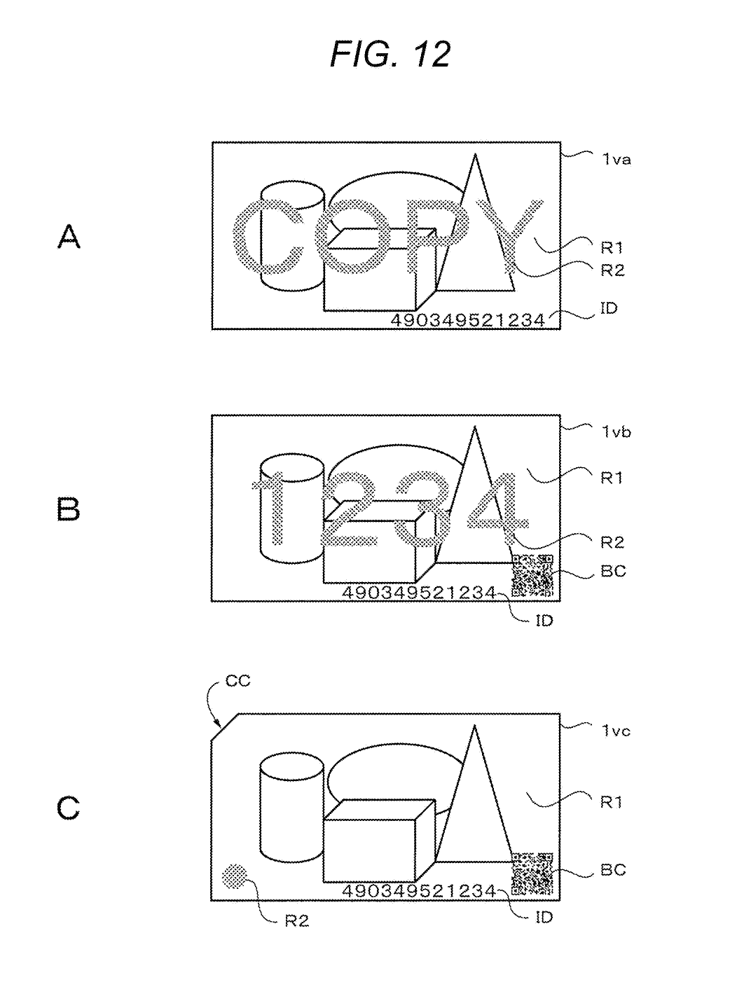

FIG. 12A is a top view illustrating a first modification of a volume hologram. For example, a volume hologram 1va is recorded with image information reproduced from an original master plate and the like. The volume hologram 1va includes a region R2 in which the wavelength spectrum of the diffracted light is different from that of the region R1. n the example of configuration as illustrated in FIG. 12A, the region R2 is provided in the shape of characters of “COPY”. In FIG. 12A, the region R2 is shown as a shaded region. In the explanation below, the region R2 is denoted as a shaded region.

In the example of configuration as illustrated in FIG. 12A, the volume hologram 1va includes not only the image information but also, as additional information, numerical string “490349521234” recorded in a holographic manner. In this case, the numerical string recorded in a holographic manner is information added as identification information ID to the volume hologram 1va.

As illustrated in FIG. 12A, the volume hologram 1va may include at least one piece of identification information ID recorded in a holographic manner. When the volume hologram 1va includes, as the additional information, a unique piece of identification information ID like a serial number, the genuineness determination function for determining the volume hologram 1va can be improved. Instead of recording the additional information to the volume hologram 1va in a holographic manner or together with holographic recording of the additional information, the additional information may be represented in a separate medium. For example, the volume hologram 1va may be adhered to a label board to be configured integrally, and the additional information may be represented in a label board by means of printing and the like.

As long as the identification information ID recorded as the additional information is unique, the identification information ID is not limited to numerical arrangement, and various kinds of information may be used. For example, various kinds of information such as serial number, manufacturer, lot number, and biometrics information can be recorded. The form of recording is not limited to characters, symbols, numerals, figures, and a combination thereof, and image information other than identification information such as one-dimensional barcode or two-dimensional barcode may be recorded. Two or more pieces of additional information may be recorded.

[Second Modification of Volume Hologram]

FIG. 12B is a top view illustrating a second modification of a volume hologram. In the example of configuration as illustrated in FIG. 12B, the volume hologram 1vb includes, as additional information, identification information ID recorded in a holographic manner. The volume hologram 1vb further includes, as the additional information, a two-dimensional barcode BC recorded in a holographic manner. It is to be understood that instead of the two-dimensional barcode, one-dimensional barcode may be recorded. By doing so, for example, the identification information ID and the two-dimensional barcode BC are associated with each other, and the genuineness determination function of the volume hologram 1vb can be improved.

The association between the identification information ID and the two-dimensional barcode BC may be, for example, matching of at least a portion of the two-dimensional barcode BC with at least a portion of the identification information ID. More specifically, for example, information obtained by decoding the two-dimensional barcode BC represents a number, and the number at the last thereof may match at least a portion of numerical string “490349521234” recorded as the identification information ID. Alternatively, it is considered that, by making association using the calculation expression, at least a portion of the identification information ID can be decoded from the information obtained by decoding the two-dimensional barcode BC. The association between the identification information ID and the two-dimensional barcode BC may not be necessarily one by one, and the association may be made between multiple pieces and multiple pieces. Encryption process may be interposed in the association between the identification information ID and the two-dimensional barcode BC.

For example, as illustrated in FIG. 12B, the shape of the region R2 and at least one of the identification information ID and the two-dimensional barcode BC may be associated. In the example of configuration as illustrated in FIG. 12B, the shape of the region R2 provided in the volume hologram 1vb is in the shape of the characters “1234”. More specifically, the shape of the region R2 matches at least a portion of the numerical string “490349521234” recorded as the identification information ID. In other words, information about the shape of the region R2 is associated with the identification information ID. In this case, encryption process may be interposed in the association between the information about the shape of the region R2 and the identification information ID.

[Third Modification of Volume Hologram]

FIG. 12C is a top view illustrating a third modification of a volume hologram. In the example of configuration as illustrated in FIG. 12C, the volume hologram 1vc includes, as additional information, identification information ID recorded in a holographic manner and two-dimensional barcode BC recorded in a holographic manner. In the example of configuration as illustrated in FIG. 12C, for example, the region R2 is provided at the lower left with respect to the recording plane of the volume hologram 1vc, and the shape is, for example, in a circular shape. By doing so, for example, the shape, the position, or the size of area of the region R2, or a combination thereof can be associated with at least one of the identification information ID and the two-dimensional barcode BC, and the genuineness determination function of the volume hologram lvc can be improved. Encryption process may be interposed in the association between the shape, the position, or the size of area of the region R2, or a combination thereof, and at least one of the identification information ID and the two-dimensional barcode BC.

At this occasion, the size of area of the region R2 is preferably within a range of 1 mm² to 50 mm², inclusive. This is because covert technical element, which is difficult to be determined without the use of a device, can be given to the volume hologram 1vc.

The size of area of the region R2 is within a range of 50 mm² or less, and it is difficult to notice, at a glance, that the volume hologram 1vc has the region R2 in which the wavelength of the diffracted light is different. The issuer of the volume hologram 1vc may have, in advance, information about the shape, the position, or the size of area of the region R2 provided in the volume hologram 1vc, or a combination thereof. The issuer of the volume hologram 1vc may determine, from the measurement with the spectrophotometer, whether the volume hologram 1vc has the region R2 or not. As long as the size of area of the region R2 is 1 mm² or more, the spectrum characteristics of the spectrophotometer can be measured.

As illustrated in FIG. 12C, the shape or the state of the volume hologram 1vc may have features.

In the example of configuration as illustrated in FIG. 12C, a cut-out portion CC is provided at the upper left of the volume hologram 1vc. More specifically, when the cut-out portion CC is provided, information such as the position, the number, and the size of cut-out portions and the shape of the cut-out portion can be added to the volume hologram 1vc as the information about the shape or the state of the volume hologram 1vc. Instead of providing the cut-out portion, or together with the arrangement of the cut-out portion, an opening portion may be provided in the volume hologram 1vc by punching or the like.

The information about the features of the shape or the state of the volume hologram 1vc includes, for example, any one of the external shape of the volume hologram 1vc, relative arrangement of the external shape and the recorded identification information, the protrusion/depression shape of the surface, the number of opening portions, the size, and the position thereof, and the external size, or a combination thereof.

The information about the features of the shape or the state of the volume hologram 1vc may be associated with at least one of the shape, the position, or the size of area of the region R2, or a combination thereof, and the identification information ID, and the two-dimensional barcode BC. In this case, encryption process may also be interposed in the association.

[Fourth Modification of Volume Hologram]

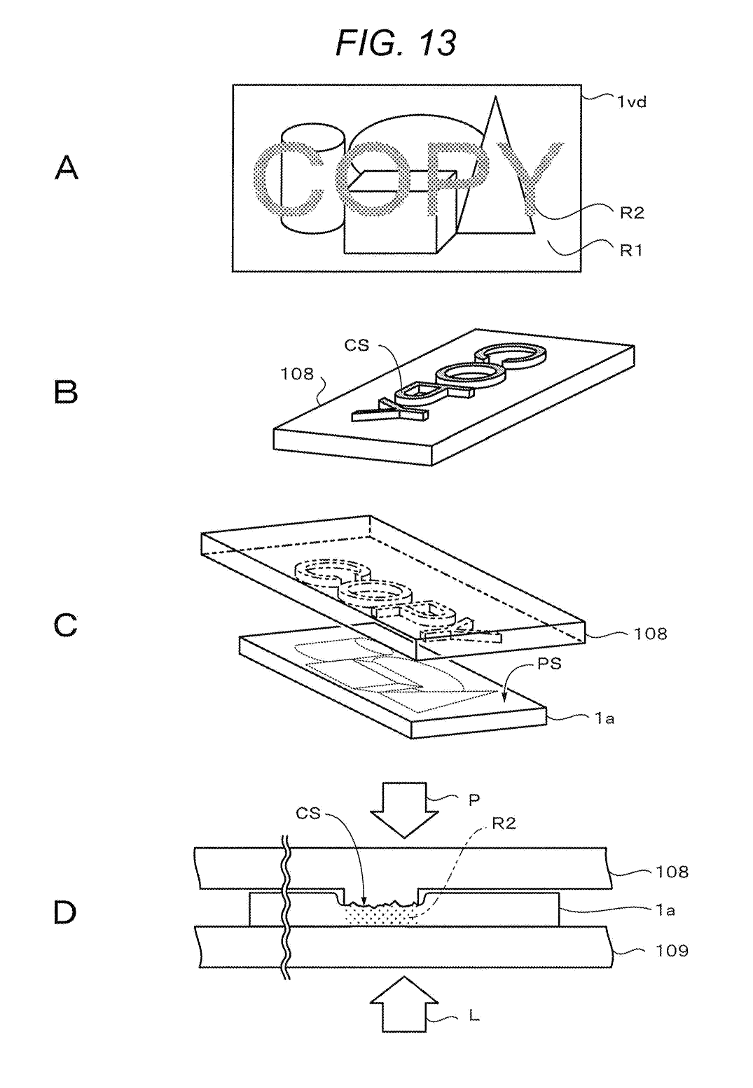

FIG. 13A is a top view illustrating a fourth modification of a volume hologram. In the example of configuration as illustrated in FIG. 13A, the volume hologram 1vd includes a region R2 in which the wavelength spectrum of the diffracted light is different from that of the region R1, and R2 has an uneven shape. The uneven shape in the region R2 is, for example, light diffraction pattern. More specifically, for example, in the region R2 of the volume hologram 1vd, the same light diffraction pattern as an embossed hologram (also referred to as rainbow hologram) is formed. Therefore, the volume hologram 1vd can be said to be a complex-type hologram having the features of the volume hologram and the embossed hologram.

Like the volume hologram, the embossed hologram also reproduces recorded information with white light. Therefore, when the volume hologram 1vd is illuminated from a predetermined angle using white light, the information (volume hologram) recorded as the difference of refractive index in the hologram recording layer 5 of the volume hologram 1vd and information recorded as the embossed hologram in the region R2 are reproduced in the same reproduction angle. More specifically, when the volume hologram 1vd is observed by emitting white light from a predetermined angle, the volume hologram of the hologram recording layer 5 and the embossed hologram of the region R2 are observed in an overlapping manner from the region R2. At this occasion, when the angle direction for illuminating the volume hologram 1vd and the observation direction of the volume hologram 1vd are changed, the color perceived in the volume hologram is constant but the color perceived in the embossed hologram of the region R2 is changed.

In this case, as explained with reference to FIGS. 4A to 4D, suppose that a person tries illegal contact copy for making a reproduction recording medium using the volume hologram 1vd as the master plate. In the contact copy, when the laser light is emitted onto the volume hologram 1vd in order to reproduce the information recorded as difference of the refractive index in the hologram recording layer 5, the information recorded as the embossed hologram in the region R2 is also reproduced in the same reproduction angle. More specifically, the reproduction recording medium is recorded with information recorded as the difference of the refractive index in the hologram recording layer 5 of the volume hologram 1vd and information recorded as the embossed hologram in the region R2.

However, in the reproduction recording medium which is illegally contact-copied (which may be hereinafter referred to as illegal copy), the information recorded as the difference of the refractive index in the hologram recording layer 5 of the volume hologram 1vd and information recorded as the embossed hologram in the region R2 are recorded as the volume hologram. Therefore, when the illegal copy is observed under white light, the color perceived in the region r2 corresponding to the region R2 does not change, even if the angle direction for illuminating the illegal copy and the observation direction of the illegal copy are changed. In other words, even if contact copy is performed, the illegal copy cannot be obtained as the same complex hologram as the volume hologram 1vd. Therefore, according to the present technique, the function of copy protection against contact copy of the volume hologram 1vd can be improved, and in addition, it becomes easy to determine the genuine product and the illegal copy, and the genuineness determination function of the volume hologram 1vd is improved.

FIGS. 13B to 13D are figures used to explain a manufacturing step of a fourth modification of a volume hologram. The volume hologram 1vd as illustrated in FIG. 13A can be manufactured according to the same steps as those for the volume hologram 1 according to an embodiment explained above.

The press die 108 as illustrated in FIGS. 13B to 13D is an example of configuration of press die used in the pressing step and the exposure step of the manufacturing steps of the volume hologram 1vd. The press die 108 is different from the press die 107 as illustrated in FIGS. 8A to 8C in that the surface of the protruding portion configured to be in contact with the exposure surface PS of the hologram recording layer 5 is the uneven plane CS corresponding to the light diffraction pattern of the embossed hologram.

By pressing the laminated body 1a in such a manner that the uneven plane CS of the press die 108 faces the exposure surface PS of the hologram recording layer 5, the portion of the laminated body 1a that is in contact with the uneven plane CS of the press die 108 can be selectively pressed. Change of property occurs in the pressed portion of the hologram recording layer 5, and the uneven shape of the uneven plane CS of the press die 108 is transferred there. More specifically, in the region R2, the light diffraction pattern of the embossed hologram can be selectively formed. Depending on the purpose of the volume hologram 1vd, the light diffraction pattern of the embossed hologram may be formed on the entire surface of the volume hologram 1vd. In FIGS. 13A and 13D, the region R2 is indicated as a shaded region.

It is to be understood that the fourth example of configuration may be combined with the first example of configuration, the second example of configuration, or the third example of configuration explained above. For example, the volume hologram 1vd may include not only the image information but also, as the additional information, identification information ID and two-dimensional barcode BC which are recorded in a holographic manner. The volume hologram 1vd may be configured to be characterized in the shape or the state of the volume hologram 1vd. For example, the volume hologram 1vd may have a cut-out portion CC and the like. The shape, the position, or the size of area of the region R2, or a combination thereof, the identification information ID, the two-dimensional barcode BC, or the shape or the state of the volume hologram 1vd may be associated with each other.

The preferred embodiments have been hereinabove explained, but preferred examples are not limited to what have been explained above.

For example, the configuration, method, steps, shapes, materials, numerical values, and the like described in the above embodiments are merely examples, and as necessary, the configuration, method, steps, shapes, materials, numerical values, and the like which are different from the above may also be used. The configuration, method, steps, shapes, materials, numerical values, and the like described in the above embodiments may be combined with each other without deviating from the gist of the present disclosure.

For example, the present technique may be configured as follows.

(1)

A manufacturing method of a volume hologram including:

a step of hologram recording for recording information in a hologram recording layer; and

a pressing step of the hologram recording layer for pressing at least a portion of the hologram recording layer in which the information is recorded,

wherein the pressing step of the hologram recording layer involves change in the hologram recording layer recorded with the information.

(2)

The manufacturing method of the volume hologram according to (1), wherein the pressing step of the hologram recording layer is performed together with emission of the light of the predetermined power for curing the hologram recording layer recorded with the information.

(3)

The manufacturing method of the volume hologram according to (1), wherein the pressing step of the hologram recording layer is performed before emission of the light of the predetermined power for curing the hologram recording layer recorded with the information.

(4)

The manufacturing method of the volume hologram according to (1), wherein the pressing step of the hologram recording layer is performed after emission of the light of the predetermined power for curing the hologram recording layer recorded with the information.

(5)

The manufacturing method of the volume hologram according to any one of (1) to (4), wherein the change is change of the wavelength spectrum of the diffracted light when white light is emitted from a predetermined angle.

(6)

The manufacturing method of the volume hologram according to (1) to (5), wherein the change is change of a thickness of the hologram recording layer.

(7)

The manufacturing method of the volume hologram according to any one of (1) to (6), wherein the change is change of reduction of a degree of clearness of an interference pattern recorded to a target of copy when contact copy is performed.

(8)

The manufacturing method of the volume hologram according to any one of (1) to (7), wherein the change is change of a refractive index in a thickness direction.

(9)

The manufacturing method of the volume hologram according to any one of (1) to (8), wherein the change is change of an interference pattern recorded in the hologram recording layer.

(10)

The manufacturing method of the volume hologram according to any one of (5) to (9), wherein the change of the wavelength spectrum of the diffracted light is such that a color difference between a pressed region and a remaining region is 0.5 or more.

(11)

The manufacturing method of the volume hologram according to any one of (6) to (10), wherein the absolute value of difference of the thickness in the pressed region and the thickness in the remaining region is within a range of more than 0 but 30% or less as compared with the thickness in the remaining region.

(12)

A volume hologram including one or more regions in which wavelength spectrums of diffracted lights are different,

wherein the thickness in the region in which the wavelength spectrum of diffracted light is different and the thickness in the remaining region are different.

(13)

The volume hologram according to (12), wherein

when white light is emitted from a predetermined angle, a color difference between the region in which the wavelength spectrum of diffracted light is different and the remaining region is within a range of 0.5 or more, and

the absolute value of difference of the thickness in the region in which the wavelength spectrum of diffracted light is different and the thickness in the remaining region is within a range of more than 0 but 30% or less as compared with the thickness in the remaining region.

(14)

The volume hologram according to (12) or (13), including at least one piece of identification information recorded in a holographic manner.

(15)

The volume hologram according to (14) is characterized in a shape or a state,

wherein information concerning the shape or the state is determined from any one of a shape, relative arrangement of the shape and recorded identification information, an uneven shape of a surface, a number, size, position, and external size of an opening portion, or a combination thereof, and

at least one piece of information about the shape or the state and the identification information are associated.

(16)

The volume hologram according to (12) to (15), wherein a size of area of at least one region of the regions in which the wavelength spectrums of diffracted lights are different is within a range of 1 mm² or more and 50 mm² or less.

(17)

A volume hologram including a hologram recording layer including one or more regions formed with change,

wherein the region formed with the change is obtained by pressing at least a portion of the hologram recording layer recorded with the information.

(18)

A shift method of a wavelength spectrum of a diffracted light, wherein the wavelength spectrum of the diffracted light is partially changed by partially pressing a photosensitive material recorded with a hologram.

In the above embodiments, the light-cured photopolymer is applied to the principal surface of the base material layer, whereby the laminated body of the hologram recording layer and the base material layer is configured. But the embodiments are not limited thereto.

For example, the protection layer may be used as a support body, and light-cured photopolymer may be applied to the principal surface of the protection layer, whereby the laminated body of the hologram recording layer and the base material layer is configured. In this case, the volume hologram may be configured as, for example, a laminated body of an adhesive layer, a hologram recording layer, and a protection layer, and the base material layer may be omitted. At this occasion, in order to prevent chemical reaction between the hologram recording layer and the adhesive layer, a blocking layer is preferably interposed between the hologram recording layer and the adhesive layer.

The present technique can be applied to an identification medium for identifying genuineness such as a package for packing goods, a non-contact IC cards, an ID card, a bank card, a credit card, an employee ID card, a student card, a commuter pass, a driver's license, a passport, a visa, securities, a passbook, a stamp, a mobile phone, money, a gold note, a certificate, a gift certificate, painting, a ticket, and a public sports voting ticket.

### REFERENCE SIGNS LIST

1 volume hologram
1va volume hologram
1vb volume hologram
1vc volume hologram
1vd volume hologram
3 protection layer
5 hologram recording layer
7 base material layer
R1 region in which the wavelength of the peak of the diffraction efficiency is substantially the same as the recording wavelength
R2 region having wavelength spectrum different from the other region
107 press die
108 press die
109 support body
P pressing force
L emission of ultraviolet ray of predetermined power
ID identification information
BC two-dimensional barcode
CC cut-out portion
CS uneven plane

1. A manufacturing method of a volume hologram comprising:
a step of hologram recording for recording information in a hologram recording layer; and
a pressing step of the hologram recording layer for pressing at least a portion of the hologram recording layer in which the information is recorded,
wherein the pressing step of the hologram recording layer involves change in the hologram recording layer recorded with the information.

2. The manufacturing method of the volume hologram according to claim 1, wherein the pressing step of the hologram recording layer is performed together with emission of the light of the predetermined power for curing the hologram recording layer recorded with the information.

3. The manufacturing method of the volume hologram according to claim 1, wherein the pressing step of the hologram recording layer is performed before emission of the light of the predetermined power for curing the hologram recording layer recorded with the information.

4. The manufacturing method of the volume hologram according to claim 1, wherein the pressing step of the hologram recording layer is performed after emission of the light of the predetermined power for curing the hologram recording layer recorded with the information.

5. The manufacturing method of the volume hologram according to claim 1, wherein the change is change of reduction of a degree of clearness of an interference pattern recorded to a target of copy when contact copy is performed.

6. The manufacturing method of the volume hologram according to claim 1, wherein the change is change of a refractive index in a thickness direction.

7. The manufacturing method of the volume hologram according to claim 1, wherein the change is change of an interference pattern recorded in the hologram recording layer.

8. The manufacturing method of the volume hologram according to claim 1, wherein the change is change of a thickness of the hologram recording layer.

9. The manufacturing method of the volume hologram according to claim 1, wherein the change is change of the wavelength spectrum of the diffracted light when white light is emitted from a predetermined angle.

10. The manufacturing method of the volume hologram according to claim 9, wherein the change of the wavelength spectrum of the diffracted light is such that a color difference between a pressed region and a remaining region is 0.5 or more.

11. The manufacturing method of the volume hologram according to claim 8, wherein the absolute value of difference of the thickness in the pressed region and the thickness in the remaining region is within a range of more than 0 but 30% or less as compared with the thickness in the remaining region.

12. A volume hologram comprising one or more regions in which wavelength spectrums of diffracted lights are different,
wherein the thickness in the region in which the wavelength spectrum of diffracted light is different and the thickness in the remaining region are different.

13. The volume hologram according to claim 12, wherein
when white light is emitted from a predetermined angle, a color difference between the region in which the wavelength spectrum of diffracted light is different and the remaining region is 0.5 or more, and
the absolute value of difference of the thickness in the region in which the wavelength spectrum of diffracted light is different and the thickness in the remaining region is within a range of more than 0 but 30% or less as compared with the thickness in the remaining region.

14. The volume hologram according to claim 12, comprising at least one piece of identification information recorded in a holographic manner.

15. The volume hologram according to claim 12, wherein a size of area of at least one region of the regions in which the wavelength spectrums of diffracted lights are different is within a range of 1 mm² or more and 50 mm² or less.

16. The volume hologram according to claim 14, which is characterized in a shape or a state,
wherein information concerning the shape or the state is determined from any one of a shape, relative arrangement of the shape and recorded identification information, an uneven shape of a surface, a number, size, position, and external size of an opening portion, or a combination thereof, and
at least one piece of information about the shape or the state and the identification information are associated.

17. A volume hologram comprising a hologram recording layer including one or more regions formed with change,
wherein the region formed with the change is obtained by pressing at least a portion of the hologram recording layer recorded with the information.

18. A shift method of a wavelength spectrum of a diffracted light, wherein the wavelength spectrum of the diffracted light is partially changed by partially pressing a photosensitive material recorded with a hologram.
